(19) United States
(12) Patent Application Publication
(10) Pub. No.: US 2022/0286994 A1
(43) Pub. Date: Sep. 8, 2022

(54) TECHNIQUES FOR TUNNELING FOR A MULTI-SUBSCRIPTION USER EQUIPMENT

(71) Applicant: QUALCOMM Incorporated, San Diego, CA (US)

(72) Inventors: Vikram SINGH, San Diego, CA (US); Mutaz Zuhier Afif SHUKAIR, San Diego, CA (US); Yong XIE, San Diego, CA (US); Qingxin CHEN, San Diego, CA (US); Carlos Marcelo Dias PAZOS, Carlsbad, CA (US); Suli ZHAO, San Diego, CA (US); Can ZHAO, San Diego, CA (US); Rishav REJ, San Diego, CA (US); Bhupesh Manoharlal UMATT, Poway, CA (US)

(21) Appl. No.: 17/653,412

(22) Filed: Mar. 3, 2022

Related U.S. Application Data
(60) Provisional application No. 63/156,765, filed on Mar. 4, 2021.

(51) Int. Cl. H04W 60/00; H04W 76/16; H04W 8/18; H04W 76/12; H04W 24/04

(52) U.S. Cl. CPC H04W 60/005; H04W 76/16; H04W 8/18; H04W 76/12; H04W 24/04; H04W 88/06

(57) ABSTRACT

In some aspects, a user equipment (UE) may communicate using a first radio access technology (RAT) for a first subscription of the UE, wherein the first RAT is selected from a group that includes a first cellular RAT associated with the first subscription, a second cellular RAT associated with a second subscription of the UE, and a wireless local area network (WLAN) RAT. The UE may communicate using a second RAT for the second subscription of the UE, wherein the second RAT is selected from the group that includes the first cellular RAT associated with the first subscription, the second cellular RAT associated with the second subscription of the UE, and the WLAN RAT. The UE may transition, based at least in part on a condition, a communication link carrying a protocol data unit (PDU) session from the second subscription to the first subscription. Numerous other aspects are described.

### CROSS-REFERENCE TO RELATED APPLICATION

This patent application claims priority to U.S. Provisional Patent Application No. 63/156,765, filed on Mar. 4, 2021, entitled “TECHNIQUES FOR TUNNELING FOR A MULTI-SUBSCRIPTION USER EQUIPMENT,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for tunneling for a multi-subscription user equipment.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or forward link) refers to the communication link from the BS to the UE, and “uplink” (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes communicating using a first radio access technology (RAT) for a first subscription of the UE, wherein the first RAT is selected from a group that includes a first cellular RAT associated with the first subscription, a second cellular RAT associated with a second subscription of the UE, and a wireless local area network (WLAN) RAT; communicating using a second RAT for the second subscription of the UE, wherein the second RAT is selected from the group that includes the first cellular RAT associated with the first subscription, the second cellular RAT associated with the second subscription of the UE, and the WLAN RAT; and transitioning, based at least in part on a condition, a communication link carrying a protocol data unit (PDU) session from the second subscription to the first subscription.

In some aspects, the method includes deactivating a cellular radio component associated with the second subscription based at least in part on transitioning the communication link carrying the PDU session from the second subscription to the first subscription.

In some aspects, the condition is that a remaining battery power of the UE is less than or equal to a battery power threshold.

In some aspects, the condition is that a first signal quality associated with the first RAT used for the first subscription exceeds a second signal quality associated with the second RAT used for the second subscription.

In some aspects, the condition is that the first subscription is a default data subscription (DDS) and the second subscription is a non-DDS subscription.

In some aspects, the communication link carrying the PDU session is a communication link carrying an Internet Protocol Multimedia Subsystem (IMS) PDU session; and the method further comprises maintaining a first IMS registration on the first subscription and a second IMS registration on the second subscription after transitioning the communication link carrying the PDU session from the second subscription to the first subscription.

In some aspects, the condition is that the first subscription is a DDS, that the second subscription is a non-DDS subscription, that a voice call is active on the first subscription, and that voice over WLAN service is enabled on the second subscription.

In some aspects, the condition is that the first subscription is a DDS, that the second subscription is a non-DDS subscription, that a voice call is active on the second subscription, and that voice over WLAN service is enabled on the second subscription.

In some aspects, the condition is that voice over WLAN service is disabled on the second subscription.

In some aspects, the condition is that a call that originates on the second subscription experiences a call failure; and the method further comprises attempting the call on the first subscription after transitioning the communication link carrying the PDU session from the second subscription to the first subscription.

In some aspects, the condition is a radio frequency limitation associated with a first band for the first subscription and a second band for the second subscription.

In some aspects, the condition is a high priority operation or a latency-sensitive operation associated with the first subscription.

In some aspects, the condition is that Internet Protocol Multimedia Subsystem (IMS) service is not available for the second subscription.

In some aspects, the condition is a prediction of an event that will impact service on the second subscription.

In some aspects, the event is predicted based at least in part on applying one or more machine learning techniques.

In some aspects, the condition is an emergency call on the first subscription.

In some aspects, the method includes establishing a tunnel to a home network of the UE, via a network connection with another UE, based at least in part on detecting a loss of cellular coverage for the UE.

In some aspects, at least one of the first RAT for the first subscription or the second RAT for the second subscription is selected based at least in part on at least one of: a user setting stored by the UE; a RAT preference associated with at least one of the first cellular RAT, the second cellular RAT, or the WLAN RAT; at least one of an availability of the first cellular RAT, an availability of the second cellular RAT, or an availability of the WLAN RAT; or a signal quality measured for at least one of the first cellular RAT, the second cellular RAT, or the WLAN RAT.

In some aspects, the method includes monitoring at least one of availability or signal quality for at least one of the first cellular RAT, the second cellular RAT, or the WLAN RAT; selecting a different RAT, than the selected RAT, based at least in part on monitoring at least one of the availability or the signal quality; and communicating on the first subscription using the selected different RAT.

In some aspects, the communication link carrying the PDU session includes at least one of an evolved packet data gateway tunnel or a non-3GPP interworking function tunnel.

In some aspects, an apparatus of a UE for wireless communication includes a memory; and one or more processors, coupled to the memory, configured to: communicate using a first RAT for a first subscription of the UE, wherein the first RAT is selected from a group that includes a first cellular RAT associated with the first subscription, a second cellular RAT associated with a second subscription of the UE, and a WLAN RAT; communicate using a second RAT for the second subscription of the UE, wherein the second RAT is selected from the group that includes the first cellular RAT associated with the first subscription, the second cellular RAT associated with the second subscription of the UE, and the WLAN RAT; and transition, based at least in part on a condition, a communication link carrying a PDU session from the second subscription to the first subscription.

In some aspects, the one or more processors are further configured to deactivate a cellular radio component associated with the second subscription based at least in part on transitioning the communication link carrying the PDU session from the second subscription to the first subscription.

In some aspects, the condition is that a remaining battery power of the UE is less than or equal to a battery power threshold.

In some aspects, the condition is that a first signal quality associated with the first RAT used for the first subscription exceeds a second signal quality associated with the second RAT used for the second subscription.

In some aspects, the condition is that the first subscription is a DDS and the second subscription is a non-DDS subscription.

In some aspects, the communication link carrying the PDU session is a communication link carrying an IMS PDU session; and the one or more processors are further configured to maintain a first IMS registration on the first subscription and a second IMS registration on the second subscription after transitioning the communication link carrying the PDU session from the second subscription to the first subscription.

In some aspects, the condition is that the first subscription is a DDS, that the second subscription is a non-DDS subscription, that a voice call is active on the first subscription, and that voice over WLAN service is enabled on the second subscription.

In some aspects, the condition is that the first subscription is a DDS, that the second subscription is a non-DDS subscription, that a voice call is active on the second subscription, and that voice over WLAN service is enabled on the second subscription.

In some aspects, the condition is that voice over WLAN service is disabled on the second subscription.

In some aspects, the condition is that a call that originates on the second subscription experiences a call failure; and the one or more processors are further configured to attempt the call on the first subscription after transitioning the communication link carrying the PDU session from the second subscription to the first subscription.

In some aspects, the condition is a radio frequency limitation associated with a first band for the first subscription and a second band for the second subscription.

In some aspects, the condition is a high priority operation or a latency-sensitive operation associated with the first subscription.

In some aspects, the condition is that IMS service is not available for the second subscription.

In some aspects, the condition is a prediction of an event that will impact service on the second subscription.

In some aspects, the event is predicted based at least in part on applying one or more machine learning techniques.

In some aspects, the condition is an emergency call on the first subscription.

In some aspects, the one or more processors are further configured to establish a tunnel to a home network of the UE, via a network connection with another UE, based at least in part on detecting a loss of cellular coverage for the UE.

In some aspects, at least one of the first RAT for the first subscription or the second RAT for the second subscription is selected based at least in part on at least one of: a user setting stored by the UE; a RAT preference associated with at least one of the first cellular RAT, the second cellular RAT, or the WLAN RAT; at least one of an availability of the first cellular RAT, an availability of the second cellular RAT, or an availability of the WLAN RAT; or a signal quality measured for at least one of the first cellular RAT, the second cellular RAT, or the WLAN RAT.

In some aspects, the one or more processors are further configured to: monitor at least one of availability or signal quality for at least one of the first cellular RAT, the second cellular RAT, or the WLAN RAT; select a different RAT, than the selected RAT, based at least in part on monitoring at least one of the availability or the signal quality; and communicate on the first subscription using the selected different RAT.

In some aspects, the communication link carrying the PDU session includes at least one of an evolved packet data gateway tunnel or a non-3GPP interworking function tunnel.

In some aspects, a non-transitory computer-readable medium storing a set of instructions for wireless communication includes one or more instructions that, when executed by one or more processors of a UE, cause the UE to: communicate using a first RAT for a first subscription of the UE, wherein the first RAT is selected from a group that includes a first cellular RAT associated with the first subscription, a second cellular RAT associated with a second subscription of the UE, and a WLAN RAT; communicate using a second RAT for the second subscription of the UE, wherein the second RAT is selected from the group that includes the first cellular RAT associated with the first subscription, the second cellular RAT associated with the second subscription of the UE, and the WLAN RAT; and transition, based at least in part on a condition, a communication link carrying a PDU session from the second subscription to the first subscription.

In some aspects, the one or more instructions further cause the UE to deactivate a cellular radio component associated with the second subscription based at least in part on transitioning the communication link carrying the PDU session from the second subscription to the first subscription.

In some aspects, the condition is that a remaining battery power of the UE is less than or equal to a battery power threshold.

In some aspects, the condition is that a first signal quality associated with the first RAT used for the first subscription exceeds a second signal quality associated with the second RAT used for the second subscription.

In some aspects, the condition is that the first subscription is a DDS and the second subscription is a non-DDS subscription.

In some aspects, the communication link carrying the PDU session is a communication link carrying an IMS PDU session; and the one or more instructions further cause the UE to maintain a first IMS registration on the first subscription and a second IMS registration on the second subscription after transitioning the communication link carrying the PDU session from the second subscription to the first subscription.

In some aspects, the condition is that the first subscription is a DDS, that the second subscription is a non-DDS subscription, that a voice call is active on the first subscription, and that voice over WLAN service is enabled on the second subscription.

In some aspects, the condition is that the first subscription is a DDS, that the second subscription is a non-DDS subscription, that a voice call is active on the second subscription, and that voice over WLAN service is enabled on the second subscription.

In some aspects, the condition is that voice over WLAN service is disabled on the second subscription.

In some aspects, the condition is that a call that originates on the second subscription experiences a call failure; and the one or more instructions further cause the UE to attempt the call on the first subscription after transitioning the communication link carrying the PDU session from the second subscription to the first subscription.

In some aspects, the condition is a radio frequency limitation associated with a first band for the first subscription and a second band for the second subscription.

In some aspects, the condition is a high priority operation or a latency-sensitive operation associated with the first subscription.

In some aspects, the condition is that IMS service is not available for the second subscription.

In some aspects, the condition is a prediction of an event that will impact service on the second subscription.

In some aspects, the event is predicted based at least in part on applying one or more machine learning techniques.

In some aspects, the condition is an emergency call on the first subscription.

In some aspects, the one or more instructions further cause the UE to establish a tunnel to a home network of the UE, via a network connection with another UE, based at least in part on detecting a loss of cellular coverage for the UE.

In some aspects, at least one of the first RAT for the first subscription or the second RAT for the second subscription is selected based at least in part on at least one of: a user setting stored by the UE; a RAT preference associated with at least one of the first cellular RAT, the second cellular RAT, or the WLAN RAT; at least one of an availability of the first cellular RAT, an availability of the second cellular RAT, or an availability of the WLAN RAT; or a signal quality measured for at least one of the first cellular RAT, the second cellular RAT, or the WLAN RAT.

In some aspects, the one or more instructions further cause the UE to: monitor at least one of availability or signal quality for at least one of the first cellular RAT, the second cellular RAT, or the WLAN RAT; select a different RAT, than the selected RAT, based at least in part on monitoring at least one of the availability or the signal quality; and communicate on the first subscription using the selected different RAT.

In some aspects, the communication link carrying the PDU session includes at least one of an evolved packet data gateway tunnel or a non-3GPP interworking function tunnel.

In some aspects, an apparatus for wireless communication includes means for communicating using a first RAT for a first subscription of the apparatus, wherein the first RAT is selected from a group that includes a first cellular RAT associated with the first subscription, a second cellular RAT associated with a second subscription of the apparatus, and a WLAN RAT; means for communicating using a second RAT for the second subscription of the apparatus, wherein the second RAT is selected from the group that includes the first cellular RAT associated with the first subscription, the second cellular RAT associated with the second subscription of the apparatus, and the WLAN RAT; and means for transitioning, based at least in part on a condition, a communication link carrying a PDU session from the second subscription to the first subscription.

In some aspects, the apparatus includes means for deactivating a cellular radio component associated with the second subscription based at least in part on transitioning the communication link carrying the PDU session from the second subscription to the first subscription.

In some aspects, the condition is that a remaining battery power of the apparatus is less than or equal to a battery power threshold.

In some aspects, the condition is that a first signal quality associated with the first RAT used for the first subscription exceeds a second signal quality associated with the second RAT used for the second subscription.

In some aspects, the condition is that the first subscription is a DDS and the second subscription is a non-DDS subscription.

In some aspects, the communication link carrying the PDU session is a communication link carrying an IMS PDU session; and further comprising means for maintaining a first IMS registration on the first subscription and a second IMS registration on the second subscription after transitioning the communication link carrying the PDU session from the second subscription to the first subscription.

In some aspects, the condition is that the first subscription is a DDS, that the second subscription is a non-DDS subscription, that a voice call is active on the first subscription, and that voice over WLAN service is enabled on the second subscription.

In some aspects, the condition is that the first subscription is a DDS, that the second subscription is a non-DDS subscription, that a voice call is active on the second subscription, and that voice over WLAN service is enabled on the second subscription.

In some aspects, the condition is that voice over WLAN service is disabled on the second subscription.

In some aspects, the condition is that a call that originates on the second subscription experiences a call failure; and further comprising means for attempting the call on the first subscription after transitioning the communication link carrying the PDU session from the second subscription to the first subscription.

In some aspects, the condition is a radio frequency limitation associated with a first band for the first subscription and a second band for the second subscription.

In some aspects, the condition is a high priority operation or a latency-sensitive operation associated with the first subscription.

In some aspects, the condition is that IMS service is not available for the second subscription.

In some aspects, the condition is a prediction of an event that will impact service on the second subscription.

In some aspects, the event is predicted based at least in part on applying one or more machine learning techniques.

In some aspects, the condition is an emergency call on the first subscription.

In some aspects, the apparatus includes means for establishing a tunnel to a home network of the apparatus, via a network connection with another UE, based at least in part on detecting a loss of cellular coverage for the apparatus.

In some aspects, at least one of the first RAT for the first subscription or the second RAT for the second subscription is selected based at least in part on at least one of: a user setting stored by the apparatus; a RAT preference associated with at least one of the first cellular RAT, the second cellular RAT, or the WLAN RAT; at least one of an availability of the first cellular RAT, an availability of the second cellular RAT, or an availability of the WLAN RAT; or a signal quality measured for at least one of the first cellular RAT, the second cellular RAT, or the WLAN RAT.

In some aspects, the apparatus includes means for monitoring at least one of availability or signal quality for at least one of the first cellular RAT, the second cellular RAT, or the WLAN RAT; means for selecting a different RAT, than the selected RAT, based at least in part on monitoring at least one of the availability or the signal quality; and means for communicating on the first subscription using the selected different RAT.

In some aspects, the communication link carrying the PDU session includes at least one of an evolved packet data gateway tunnel or a non-3GPP interworking function tunnel.

In some aspects, an apparatus for wireless communication at a user equipment (UE) includes a memory; and one or more processors, coupled to the memory. The one or more processors may be configured to communicate using a first radio access technology (RAT) for a first subscription of the UE, wherein the first RAT is a cellular RAT associated with the first subscription, where the UE is associated with a second subscription that can communicate using a communication link carrying a protocol data unit (PDU) session on the first RAT of the first subscription; and establish, with a gateway, the communication link carrying the PDU session on the first RAT of the first subscription.

In some aspects, a method of wireless communication performed at a user equipment (UE) may include communicating using a first radio access technology (RAT) for a first subscription of the UE, wherein the first RAT is a cellular RAT associated with the first subscription, where the UE is associated with a second subscription that can communicate using a communication link carrying a protocol data unit (PDU) session on the first RAT of the first subscription; and establishing, with a gateway, a communication link carrying the PDU session on the first RAT of the first subscription.

In some aspects, an apparatus for wireless communication may include means for communicating using a first radio access technology (RAT) for a first subscription of the apparatus, wherein the first RAT is a cellular RAT associated with the first subscription, where the apparatus is associated with a second subscription that can communicate using a communication link carrying a PDU session on the first RAT of the first subscription; and means for establishing, with a gateway, a communication link carrying the PDU session on the first RAT of the first subscription.

In some aspects, a non-transitory computer-readable medium storing a set of instructions for wireless communication includes one or more instructions that, when executed by one or more processors of a UE, cause the UE to: communicate using a first radio access technology (RAT) for a first subscription of the UE, wherein the first RAT is a cellular RAT associated with the first subscription, where the UE is associated with a second subscription that can communicate using a communication link carrying a protocol data unit (PDU) session on the first RAT of the first subscription; and establish, with a gateway, the communication link carrying the PDU session on the first RAT of the first subscription.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a multiple subscriber identity module UE, in accordance with the present disclosure.

FIGS. 4-12 are diagrams illustrating examples associated with tunneling for a multi-subscription UE, in accordance with the present disclosure.

FIG. 13 is a diagram illustrating an example process associated with tunneling for a multi-subscription UE, in accordance with the present disclosure.

FIG. 14 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

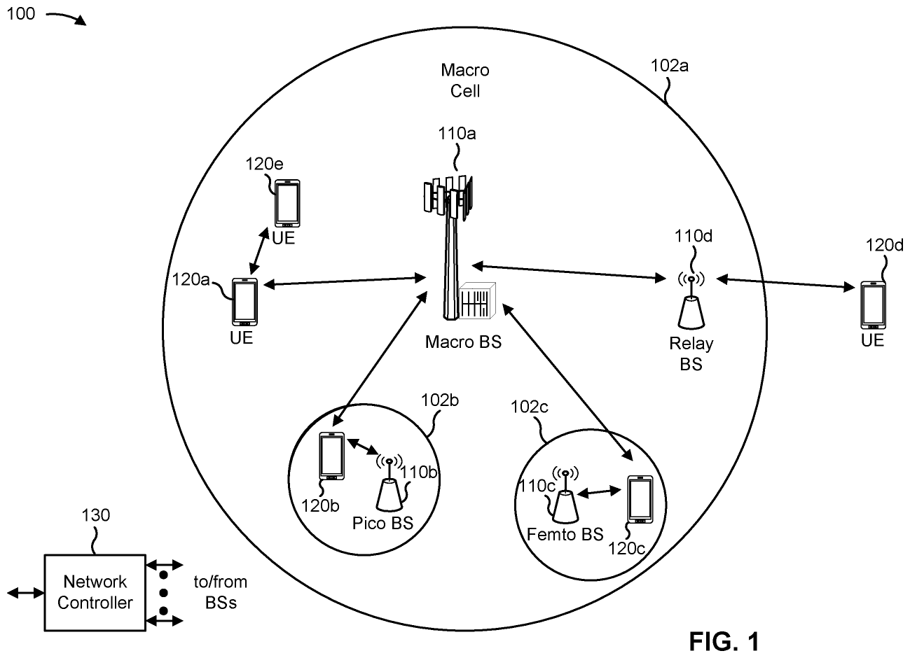

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

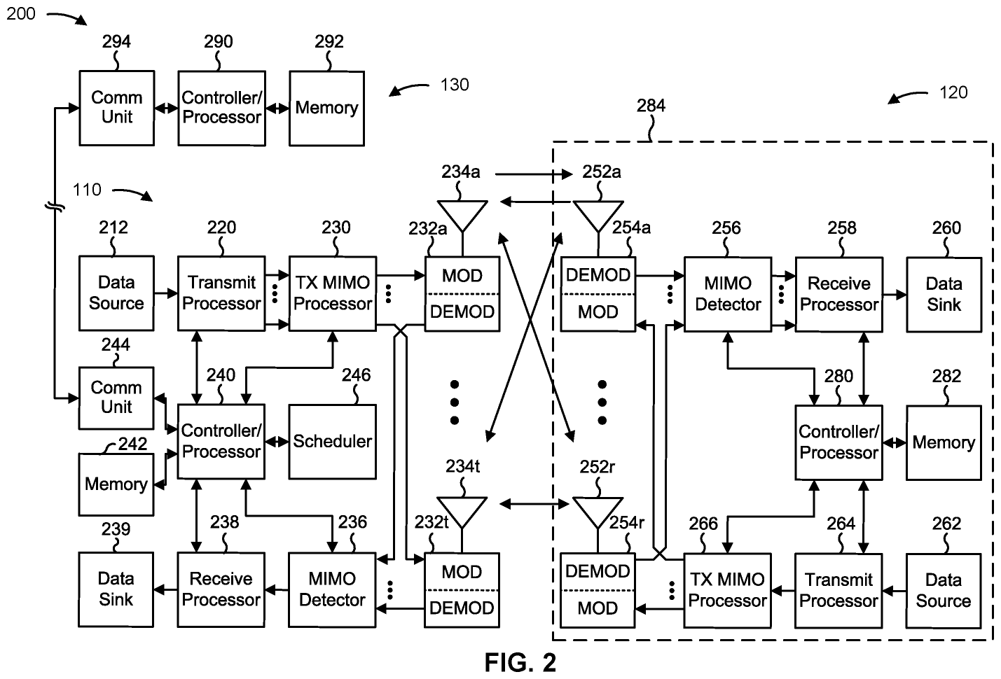

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, an/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

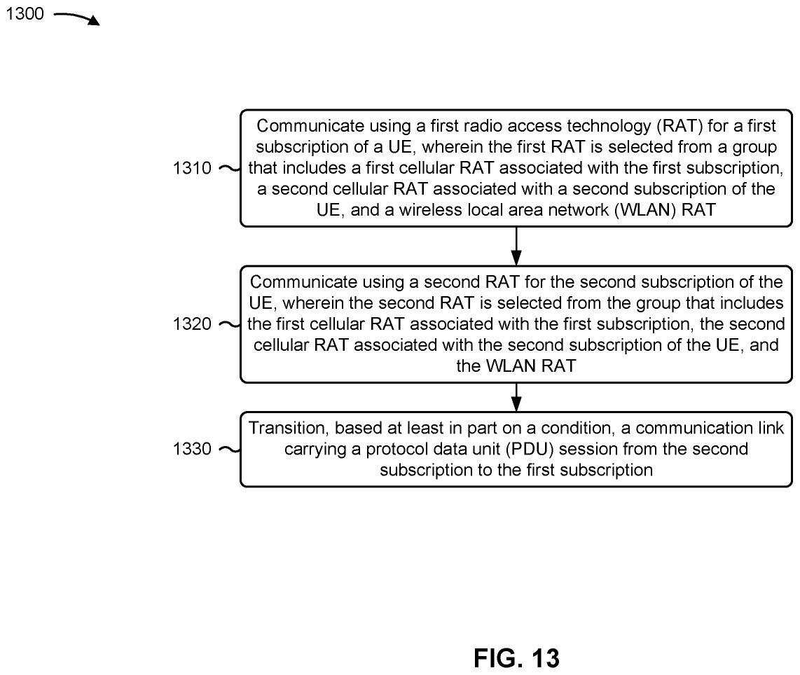

Controller/processor 240 of base station 110, controller/processor 280 of UE 120, and/or any other component(s) of FIG. 2 may perform one or more techniques associated with tunneling for a multi-subscription UE, as described in more detail elsewhere herein. For example, controller/processor 240 of base station 110, controller/processor 280 of UE 120, and/or any other component(s) of FIG. 2 may perform or direct operations of, for example, process 1300 of FIG. 13 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1300 of FIG. 13 and/or other processes as described herein. In some aspects, executing instructions may include running the instructions, converting the instructions, compiling the instructions, and/or interpreting the instructions.

In some aspects, the UE includes means for communicating using a first radio access technology (RAT) for a first subscription of the UE, wherein the first RAT is selected from a group that includes a first cellular RAT associated with the first subscription, a second cellular RAT associated with a second subscription of the UE, and a wireless local area network (WLAN) RAT; means for communicating using a second RAT for the second subscription of the UE, wherein the second RAT is selected from the group that includes the first cellular RAT associated with the first subscription, the second cellular RAT associated with the second subscription of the UE, and the WLAN RAT; and/or means for transitioning, based at least in part on a condition, a communication link carrying a protocol data unit (PDU) session from the second subscription to the first subscription. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for deactivating a cellular radio component associated with the second subscription based at least in part on transitioning the communication link carrying the PDU session from the second subscription to the first subscription. In some aspects, the UE includes means for maintaining a first IMS registration on the first subscription and a second IMS registration on the second subscription after transitioning the communication link carrying the PDU session from the second subscription to the first subscription. In some aspects, the UE includes means for establishing a tunnel to a home network of the UE, via a network connection with another UE, based at least in part on detecting a loss of cellular coverage for the UE. In some aspects, the UE includes means for monitoring at least one of availability or signal quality for at least one of the first cellular RAT, the second cellular RAT, or the WLAN RAT; means for selecting a different RAT, than the selected RAT, based at least in part on monitoring at least one of the availability or the signal quality; or means for communicating on the first subscription using the selected different RAT.

As indicated above, FIG. 2 is provided as an example. Other examples may differ from what is described with regard to FIG. 2.

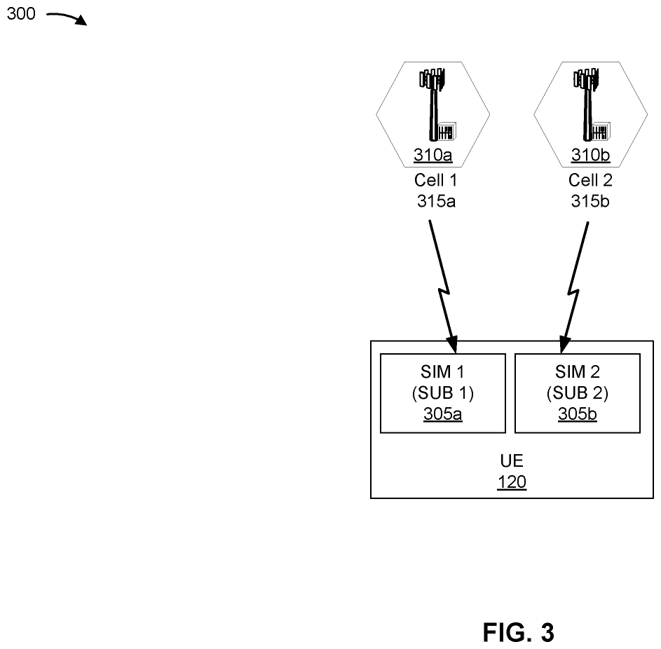

FIG. 3 is a diagram illustrating an example 300 of a multiple subscriber identity module (SIM) UE, in accordance with the present disclosure. As shown in FIG. 3, a UE 120 may be a multiple SIM (multi-SIM) UE that includes multiple SIMs (two or more SIMs), shown as a first SIM 305a and a second SIM 305b. The first SIM 305a may be associated with a first subscription (shown as SUB 1), and the second SIM 305b may be associated with a second subscription (shown as SUB 2). A subscription may be a subscription with a network operator (for example, a mobile network operator (MNO)) that enables the UE 120 to access a wireless network (for example, a radio access network (RAN)) associated with the network operator.

A SIM 305 may be a removable SIM (for example, a SIM card) or an embedded SIM (eSIM). A SIM 305 may include an integrated circuit that securely stores an international mobile subscriber identity (IMSI) and a security key, which are used to identify and authenticate a corresponding subscription associated with the SIM 305. In some cases, a SIM 305 may store a list of services that the UE 120 has permission to access using a subscription associated with the SIM 305, such as a data service or a voice service, among other examples. In some aspects, the UE 120 may be a single-SIM UE, which may be associated with multiple subscribers or a single subscriber.

As further shown in FIG. 3, the UE 120 may communicate (for example, in a connected mode, an idle mode, or an inactive mode) with a first base station 310a via a first cell 315a (shown as Cell 1) using the first SIM 305a. In this case, a first subscription (SUB 1) of the UE 120 may be used to access the first cell 315a (for example, using a first IMSI for UE identification, using a first security key for UE authentication, using a first list of services that the UE 120 is permitted to access using the first subscription, or by counting data or voice usage on the first cell against the first subscription, among other examples). Similarly, the UE 120 may communicate (for example, in a connected mode, an idle mode, or an inactive mode) with a second base station 310b via a second cell 315b (shown as Cell 2) using the second SIM 305b. In this case, a second subscription (SUB 2) of the UE 120 may be used to access the second cell 315b (for example, using a second IMSI for UE identification, using a second security key for UE authentication, using a second list of services that the UE 120 is permitted to access using the second subscription, or by counting data or voice usage on the second cell against the second subscription, among other examples).

The first base station 310a and/or the second base station 310b may include one or more of the base stations 110 described above in connection with FIG. 1. Although the first cell 315a and the second cell 315b are shown as being provided by different base stations, in some aspects, the first cell 315 and the second cell 315b may be provided by the same base station. Thus, in some aspects, the first base station 310a and the second base station 310b may be integrated into a single base station.

In some cases, the UE 120 may be capable of operating in a multi-SIM multiple standby (MSMS) mode, such as a dual SIM dual standby (DSDS) mode (e.g., when the UE 120 is associated with two subscriptions). Additionally, or alternatively, the UE 120 may be capable of operating in a multi-SIM multiple active (SR-MSMA) mode, such as a dual SIM dual active (DSDA) mode (e.g., when the UE 120 is associated with two subscriptions).

In a DSDA mode, the UE 120 is capable of concurrent active communication using both SIMS of the UE 120. Thus, a UE 120 in the DSDA mode is capable of communicating using the first SIM 305a (and the first subscription) at the same time as communicating using the second SIM 305b (and the second subscription). For example, when the UE 120 is in an active session (e.g., a voice call or another latency sensitive service, such as online gaming, stock trading, or an over-the-top (OTT) service) using the first SIM 305a, the UE 120 is capable of receiving a notification of a voice call using the second SIM 305b without interrupting communications that use the first SIM 305a, and without tuning or switching away from the first cell 315a to tune to the second cell 315b.

In a DSDS mode, the UE 120 is not capable of concurrent active communication using both SIMS of the UE 120. Thus, a UE 120 in the DSDS mode is not capable of communicating using the first SIM 305a (and the first subscription) at the same time as communicating using the second SIM 305b (and the second subscription). However, a UE 120 in the DSDS mode may be capable of switching between two separate mobile network services, may include hardware for maintaining multiple connections (for example, one connection per SIM) in a standby state, or may include hardware (for example, multiple transceivers) for maintaining multiple network connections at the same time, among other examples. However, a UE 120 in the DSDS mode may be capable of receiving data on only one connection at a time because radio frequency resources are shared between the multiple subscriptions. For example, a UE 120 in the DSDS mode may be associated with multiple subscriptions but may include only a single transceiver shared by the multiple subscriptions, a single transmit chain shared by the multiple subscriptions, or a single receive chain shared by the multiple subscriptions, among other examples.

In some examples, a UE 120 may be capable of operating in a DSDA mode for a first combination of RATs, and may not be capable of operating in a DSDA mode for a second combination of RATs. For example, the UE 120 may be capable of operating in a DSDA mode for NR+NR, where the first cell 315a (as well as the first SIM 305a and the first subscription) uses an NR RAT and the second cell 315b (as well as the second SIM 305b and the second subscription) also uses the NR RAT. However, the UE 120 may not be capable of operating in a DSDA mode for NR+LTE, where one of the first cell 315a (as well as the first SIM 305a and the first subscription) uses an NR RAT and the second cell 315b (as well as the second SIM 305b and the second subscription) uses an LTE RAT (or vice versa). In some aspects, the UE 120 may not be capable of operating in the DSDA mode for the second combination of RATs (e.g., NR+LTE), but be capable of operating in a DSDS mode for the second combination of RATs. This UE design reduces design costs as compared to enabling the UE 120 to operate using the DSDA mode for the second combination of RATs.

In one example, the UE 120 may use a cellular RAT (e.g., an LTE RAT, an NR RAT, or the like) of the first subscription to access services for the second subscription if a wireless local area network (WLAN) RAT (e.g., a WiFi RAT) is not available for the second subscription. For example, the UE 120 may sometimes use a WLAN RAT for the second subscription to access a core network service (e.g., a core network service provided by a cellular network operator or mobile network operator), such as an Internet Protocol Multimedia Subsystem (IMS) service or a rich communication service (RCS), via a gateway. However, if the WLAN RAT is not available for the second subscription, then the UE 120 may use a cellular RAT of the first subscription to access the core network service via the gateway.

The gateway may include, for example, an evolved packet data gateway (ePDG) or a non-3GPP interworking function (N3IWF) gateway. The gateway may enable the UE 120 to attach to, communicate with, and/or exchange signaling messages with a 3GPP core network (e.g., an LTE core network, an NR core network, or the like) via a non-3GPP connection (e.g., a WLAN connection). After attachment, a secure connection may be established between the UE 120 and the gateway, via which protocol data unit (PDU) messages (e.g., non-access stratum (NAS) messages and/or other messages) can be exchanged between the UE 120 and a control plane function of the core network. In some examples, the UE 120 and the gateway may establish a communication link (e.g., a tunnel) carrying a PDU session (sometimes referred to as a PDU tunnel), such as an Internet Protocol Security (IPSec) tunnel carrying a PDU session, an ePDG tunnel carrying a PDU session (e.g., that allows the UE 120 to exchange signaling messages with an ePDG), or an N3IWF tunnel carrying a PDU session (e.g., that allows the UE 120 to exchange signaling messages with an N3IWF gateway), via which messages are securely exchanged between the UE 120 and the gateway. As used herein, “tunnel” may refer to a communication link (e.g., between two endpoint devices).

For example, the UE 120 may operate in a dual SIM dual IMS (DSDI) mode or a dual SIM dual voice over LTE (DSDV) mode, where both SIMs can be used for respective idle mode cellular network connections, but when a cellular network connection is active on a first subscription (e.g., in a voice call), then the cellular network connection is limited on a second subscription. Unlike in a DSDS mode, in a DSDI or DSDV mode, calls and texts can still be transmitted and received on the second subscription when the cellular network connection is active on the first subscription because the calls and texts can be transmitted as IMS data over the active cellular network connection of the first subscription and then routed to an appropriate gateway (e.g., an ePDG used for IMS over WiFi). Thus, a UE 120 operating in a DSDI mode or a DSDV mode may be capable of using a cellular RAT of the first subscription to access an IMS service (or an RCS) via the gateway for communications of the second subscription when a WLAN RAT of the second subscription is unavailable.

There are some scenarios or conditions (other than a WLAN RAT of the second subscription being unavailable) in which using a cellular RAT of the first subscription, to access an IMS service (or an RCS) via a gateway for communications of the second subscription, can improve performance. Some techniques and apparatuses described herein enable transitioning of a communication link carrying the PDU session (e.g., an ePDG tunnel, an N3IWF tunnel, an IPSec tunnel, or the like) from one subscription of a UE 120 to another subscription of the UE 120 in these scenarios, which can improve quality of service provided to the UE 120, can extend battery power, can enable communications on multiple subscriptions, can prevent interruption to high priority services, can reduce call drops or service outages, or the like, as described in more detail below.

As indicated above, FIG. 3 is provided as an example. Other examples may differ from what is described with regard to FIG. 3.

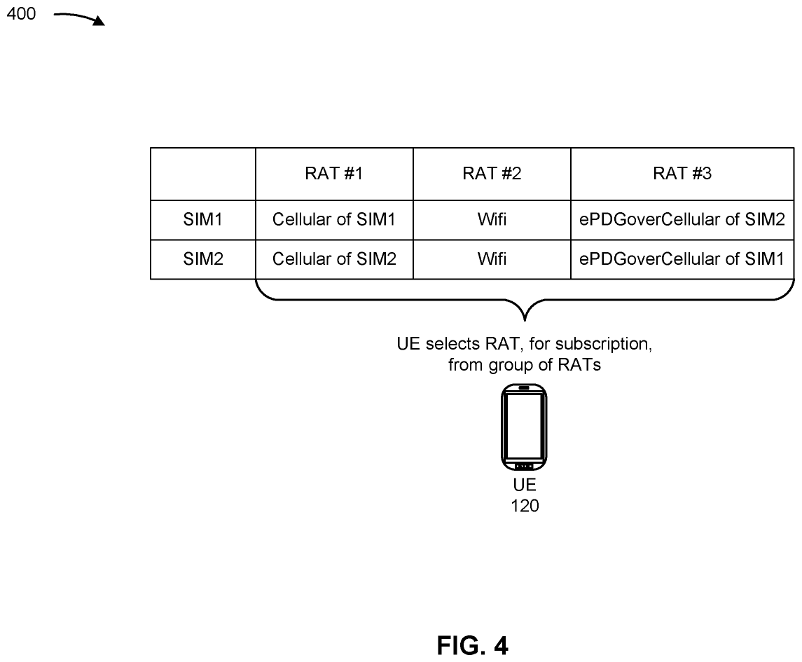

FIG. 4 is a diagram illustrating an example 400 associated with tunneling for a multi-subscription UE, in accordance with the present disclosure.

As shown in FIG. 4, a UE 120 may be capable of using, for a first subscription (SIM1) of the UE 120, a first cellular RAT associated with the first subscription (shown as “Cellular of SIM1”), a WLAN RAT (shown as “Wifi”), and/or a second cellular RAT associated with a second subscription of the UE 120 (shown as “ePDGoverCellular of SIM2”). If the UE 120 uses, for the first subscription, the second cellular RAT associated with the second subscription, then the UE 120 may need to transition a communication link carrying a PDU session from the first subscription to the second subscription.

Similarly, the UE 120 may be capable of using, for the second subscription (SIM2) of the UE 120, a second cellular RAT associated with the second subscription (shown as “Cellular of SIM2”), a WLAN RAT (shown as “Wifi”), and/or a first cellular RAT associated with a first subscription of the UE 120 (shown as “ePDGoverCellular of SIM1”). If the UE 120 uses, for the second subscription, the first cellular RAT associated with the first subscription, then the UE 120 may need to transition a communication link carrying a PDU session from the second subscription to the first subscription.

In some aspects, the UE 120 may select a first RAT, for the first subscription, from a group of RATs that includes the first cellular RAT associated with the first subscription, the second cellular RAT associated with the second subscription, and the WLAN RAT. The UE 120 may communicate using the first RAT for the first subscription. Similarly, the UE 120 may select a second RAT, for the second subscription, from a group of RATs that includes the first cellular RAT associated with the first subscription, the second cellular RAT associated with the second subscription, and the WLAN RAT. Thus, the UE 120 may select the first RAT and the second RAT from the same group of RATs, in some aspects. The UE 120 may communicate using the second RAT for the second subscription.

In some aspects, the UE 120 may select a RAT for a subscription based at least in part on a user setting stored by the UE 120. For example, a user may interact with the UE 120 to input a user setting, such as to enable or disable Voice over WLAN (e.g., Voice over WiFi, or VoWifi), to enable or disable cellular communication (e.g., unless a battery of the UE 120 is charging), or the like. Additionally, or alternatively, the UE 120 may select a RAT for a subscription based at least in part on a RAT preference stored by the UE 120. For example, the UE 120 may store a RAT preference to prioritize cellular RATs over a WLAN RAT, to prioritize a WLAN RAT over cellular RATs, to indicate that the UE 120 is to use only a cellular RAT (and not a WLAN RAT), to indicate that the UE 120 is to use only a WLAN RAT (and not a cellular RAT), or the like.

Additionally, or alternatively, the UE 120 may select a RAT for a subscription based at least in part on availabilities of one or more RATs. For example, the UE 120 may select a RAT from the group of RATs based at least in part on an availability of the first cellular RAT, an availability of the second cellular RAT, and/or an availability of the WLAN RAT. For example, if a particular RAT is not available, then the UE 120 may not select that RAT. Additionally, or alternatively, the UE 120 may select a RAT for a subscription based at least in part on signal qualities measured for one or more RATs. For example, the UE 120 may measure a first signal quality of the first cellular RAT, may measure a second signal quality of the second cellular RAT, and may measure a third signal quality of the WLAN RAT. The UE 120 may select a RAT from the group of RATs based at least in part on the measured signal qualities. A signal quality may be indicated by, for example, RSRP, RSSI, RSRQ, and/or CQI.

In some aspects, the UE 120 may use more than one of the above techniques to select a RAT for a subscription. For example, if cellular RATs are preferred, then the UE 120 may select a cellular RAT with the best signal quality even if the WLAN RAT has a better signal quality than the cellular RAT with the best signal quality.

After selecting a RAT for a subscription, the UE 120 may establish a communication link carrying a PDU session to enable mobile network operator services (e.g., IMS services and/or RCS services) on that RAT. The communication link carrying the PDU session may include, for example, an ePDG tunnel, an N3IWF tunnel, and/or an IPSec tunnel. After establishing the communication link carrying the PDU session, the UE 120 may continue to monitor user settings, RAT preferences, RAT availability, and/or RAT signal quality for the first cellular RAT, the second cellular RAT, and/or the WLAN RAT (as described above). If one or more of these parameters change, the UE 120 may select a different RAT for the subscription as appropriate. For example, the UE 120 may select a different RAT if the relative signal quality of two RATs changes. After selecting a different RAT for a subscription, the UE 120 may communicate using the different RAT for that subscription.

In some aspects, the UE 120 may determine that a condition is satisfied, and may transition a communication link carrying a PDU session from one subscription to another subscription, as described in more detail below. The condition may relate to transitioning the communication link carrying the PDU session from one subscription to another subscription, such as associated with a user activity of the UE 120 or a device configuration of the UE 120, as also described in more detail below. Although FIG. 4 shows an example of an ePDG tunnel being used for cross-subscription cellular communication, in some aspects, an N3IWF tunnel may be used (e.g., using an N3IWFoverCellular RAT), or another type of tunnel may be used.

By enabling the UE 120 to select, for a particular subscription, a cellular RAT associated with another subscription, the UE 120 may be capable of communicating using and obtaining operator services for the particular subscription even if the cellular RAT of the particular subscription and the WLAN RAT both have poor quality and/or are unavailable. This improves performance and maintains service continuity.

As indicated above, FIG. 4 is provided as an example. Other examples may differ from what is described with regard to FIG. 4.

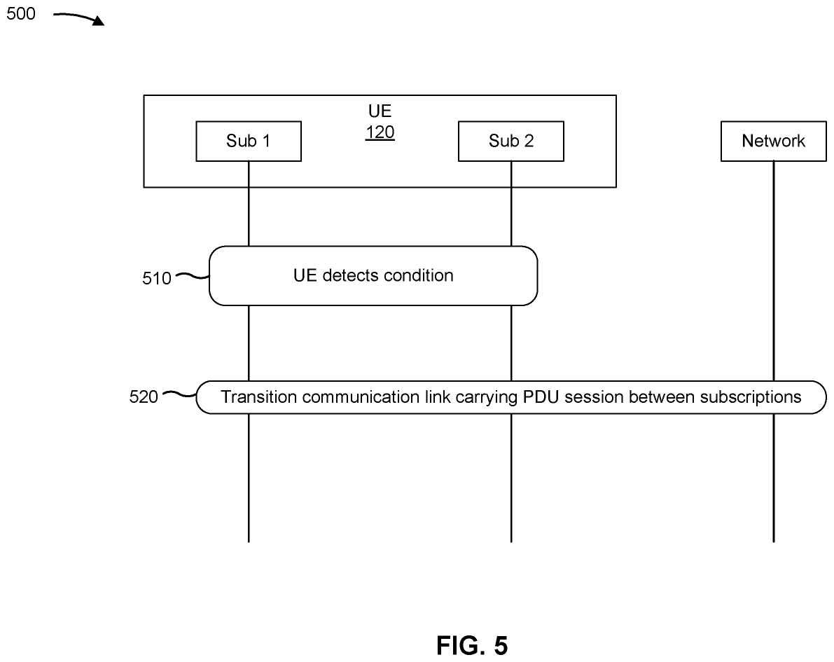

FIG. 5 is a diagram illustrating an example 500 associated with tunneling for a multi-subscription UE, in accordance with the present disclosure. As shown in FIG. 5, a UE 120 may be associated with multiple subscriptions, including a first subscription (Sub1 or Sub 1) and a second subscription (Sub2 or Sub 2). In some aspects, the UE 120 may select a first RAT for the first subscription and may communicate using the first RAT for the first subscription, such as by using one or more techniques described above in connection with FIG. 4. In some aspects, the UE 120 may select a second RAT for the second subscription and may communicate using the second RAT for the second subscription, such as by using one or more techniques described above in connection with FIG. 4. The UE 120 may communicate with a network, which may include a base station 110 and/or one or more devices included in a core network, such as a gateway (e.g., a packet data network (PDN) gateway, an ePDG gateway, and/or an N3IWF gateway).

In some aspects, when establishing a connection with the network for a subscription, the UE 120 may establish a communication link carrying a PDU session to obtain operator services for that subscription. The UE 120 and the network may exchange signaling messages via the communication link carrying the PDU session, such as control plane messages, NAS messages, upper layer signaling message, or the like. In some aspects, the UE 120 may establish a first communication link carrying a first PDU session for the first subscription, and may establish a second communication link carrying a second PDU session for the second subscription.

As shown by reference number 510, the UE 120 may detect a condition. The condition may relate to transitioning a communication link carrying a PDU session from one subscription to another subscription and/or may trigger the UE 120 to transition a communication link carrying a PDU session from one subscription to another subscription. In some aspects, the UE 120 may detect the condition by determining that the condition is satisfied. In some aspects, the condition may be associated with a device configuration of the UE 120. For example, the condition may relate to a state of one or more components of the UE 120 (such as a battery or a subscription), a radio frequency limitation of the UE 120, or a prediction of an event, among other examples. In some aspects, the condition may be associated with a user activity of the UE 120. For example, the condition may relate to a call of the UE 120, availability of service for a particular subscription, a high-priority or latency-sensitive operation, or enablement or disablement of a service, among other examples. Example conditions are described below.

As shown by reference number 520, the UE 120 may transition a communication link carrying a PDU session from one subscription to another subscription based at least in part on detecting the condition. In some aspects, the UE 120 may transition a first communication link carrying a PDU session, established for the first subscription, from the first subscription to the second subscription. Alternatively, the UE 120 may transition a second communication link carrying a PDU session, established for the second subscription, from the second subscription to the first subscription. Examples of transitioning a communication link carrying a PDU session based at least in part on a condition are described below.

In some aspects, the condition (e.g., associated with the device configuration of the UE) is that a remaining battery power of the UE 120 is less than or equal to a battery power threshold. For example, the UE 120 may determine that a remaining battery power of the UE 120 is less than or equal to a battery power threshold (e.g., 5%, 10%, 15%, 20%, or another battery power threshold), and may transition a communication link carrying a PDU session between subscriptions based at least in part on this determination. In some aspects, if the UE 120 determines that the remaining battery power is less than or equal to a threshold, then the UE 120 may transition the communication link carrying the PDU session to the subscription associated with better signal quality (e.g., better cellular RAT signal quality). The UE 120 may measure signal quality based at least in part on determining that the remaining battery power is less than or equal to the threshold, or may use a previous measurement (e.g., measured before the determination).

For example, if the first RAT used for the first subscription has better signal quality, then the UE 120 may transition the communication link carrying the PDU session of the second subscription (e.g., that uses the second RAT) to the first subscription (e.g., that uses the first RAT). In some aspects, after the transition, the UE 120 may deactivate one or more cellular radio components associated with the subscription from which the communication link carrying the PDU session is moved (e.g., the second subscription in the above example). For example, the UE 120 may deactivate one or more components (e.g., a cellular modem and/or a radio frequency (RF) component) that provide communication capabilities for the second subscription, as long as those one or more components are not needed for communications for the first subscription. As a result, the UE 120 may conserve battery power and extend battery life.

Alternatively, if the UE 120 determines that the remaining battery power is less than or equal to a threshold, then the UE 120 may transition the communication link carrying the PDU session away from a non-default data subscription (non-DDS or nDDS) and to a default data subscription (DDS). For example, if the first subscription is a DDS and the second subscription is a non-DDS, then the UE 120 may transition the communication link carrying the PDU session from the second subscription to the first subscription. As an example, one of the subscriptions may be a primary subscription and configured or set as a DDS, and the other subscription may be a secondary subscription and configured or set as a non-DDS. For example, the primary subscription (e.g., DDS) may be configured to transfer data (e.g., application data) and call traffic (e.g., voice over cellular call traffic, such as VoLTE traffic or VoNR traffic), while the secondary subscription (e.g., the non-DDS) may be configured only for call traffic (and not data traffic). In this example, after the transition, the UE 120 may deactivate one or more components that provide communication capabilities for the non-DDS. By transitioning the communication link carrying the PDU session to the DDS, the UE 120 is capable of using a wider range of services (e.g., voice services and data services) than if the communication link carrying the PDU session were transitioned to the non-DDS.

In some aspects, the condition (e.g., associated with the user activity of the UE 120) is that a call that originates on a particular subscription experiences a call failure. In some aspects, the call failure may be a result of an access stratum (AS) layer failure, such as a random access channel (RACH) failure or a radio resource control (RRC) failure. In some aspects, the call failure may be a result of a NAS layer failure, such as a call service rejection (e.g., Service_Reject). In some aspects, the call failure may be a result of network congestion (e.g., in a home cellular network of the UE 120 and/or the subscription). In some aspects, the call failure may be a result of access class barring (ACB) for a network or cell used by the UE 120 and/or the subscription (e.g., ACB for IMS services).

For example, the UE 120 may determine that a call that originates on the second subscription experiences a call failure, and may transition a communication link carrying a PDU session from the second subscription to the first subscription based at least in part on this determination. In some aspects, the UE 120 may attempt (e.g., redial) the call on the first subscription after transitioning the communication link carrying the PDU session to the first subscription. This may increase the probability of successfully setting up a call. In some aspects, this technique may be used for emergency calls to increase the likelihood of successfully establishing the emergency call.

In some aspects, the condition (e.g., associated with the user activity of the UE 120) is that a high priority operation or a latency-sensitive operation associated with a particular subscription. A high priority operation may include, for example, a stock-trading operation (e.g., executed using a stock-trading application or website), a ticket-purchasing operation (e.g., executed using a ticket-purchasing application or website), or the like. A latency-sensitive operation may include, for example, online gaming, an operation with a high quality of service (QoS) requirement, an ultra-reliable low latency communication (URLLC), or the like. For example, the UE 120 may determine that a high priority or latency-sensitive operation is being performed on the first subscription, and may transition a communication link carrying a PDU session from the second subscription to the first subscription based at least in part on this determination. As a result, the high priority or latency-sensitive operation is less likely to be interrupted (e.g., by a tune away from the first subscription or a switch to the second subscription).

In some aspects, the condition (e.g., associated with the user activity of the UE 120) is that IMS service is not available for a particular subscription. In this example, the UE 120 may transition a communication link carrying a PDU session from the particular subscription, for which IMS service is not available, to another subscription for which IMS service is available. As a result, IMS services may be provided for the particular subscription, thereby improving performance. In some aspects, IMS service may be unavailable for a subscription if the subscription is roaming on a roaming network that has a data roaming agreement with a home network of the subscription, but does not have an IMS roaming agreement with the home network. As another example, IMS service may be unavailable for a subscription if the subscription is on a roaming network and is out of service (00S) because the roaming network does not have any roaming agreement with the home network. As another example, IMS service may be unavailable for a subscription if the subscription is using a Citizens Broadband Radio Service (CBRS) for network access, which is a data-only service without IMS service. In these examples, transitioning the communication link carrying the PDU session enables the subscription to access home network services (e.g., IMS services). It should be noted that the transitioning of the communication link carrying the PDU session from the particular subscription to the other subscription can be performed by a single SIM (SSIM) UE. For example, a UE (e.g., a SSIM UE) may communicate using a cellular RAT associated with a first subscription of the UE. A second subscription of the UE may be capable of communicating using a communication link with a gateway (such as may carry an IMS PDU session) on the cellular RAT of the first subscription. The UE may determine that the IMS PDU session cannot be established via a roaming cellular network (such as associated with the cellular RAT associated with the first subscription, or may prefer to use a WLAN RAT rather than a cellular RAT (such as based at least in part on a user setting). The UE may establish, with a gateway, a communication link carrying the IMS PDU session via the cellular RAT of the first subscription or may transition a communication link carrying the IMS PDU session to the cellular RAT of the first subscription. Thus, the UE can still use a home operator's IMS services while roaming. In some examples, the second subscription may be an embedded SIM (eSIM). Furthermore, the transitioning or establishment of the communication link carrying the PDU session to use the cellular RAT can be performed by an SSIM having a single subscription. For example, the single subscription may be referred to as a first subscription (when using the cellular RAT associated with the subscription) and as a second subscription (when performing tunneling to communicate with a gateway via the cellular RAT associated with the subscription), since only one of the first subscription or the second subscription can be active at a time (e.g., communication via a PDU session with a gateway on the cellular RAT of the subscription cannot be performed at the same time as other communications on the cellular RAT of the subscription).

In some aspects, the condition (e.g., associated with the device configuration of the UE 120) is a prediction of an event that will impact service on particular subscription (e.g., that will negatively impact the particular subscription). In this example, the UE 120 may transition a communication link carrying a PDU session from the particular subscription, for which the event is predicted, to another subscription to mitigate the predicted negative impact. The event may include, for example, handover to another cell (e.g., intra-RAT handover), handover to another RAT (e.g., inter-RAT handover), radio link failure, movement to a poor coverage area (or an area without coverage), a loss of coverage, an out of service event, or a transition of the UE 120 from a DSDA mode to a DSDS mode. In some aspects, the UE 120 may predict the event based at least in part on applying one or more machine learning techniques, which may be trained on historical data and applied to current data associated with the UE 120.

In some aspects, the condition (e.g., associated with the user activity of the UE 120) is an emergency call on a particular subscription. In this example, the UE 120 may transition a communication link carrying a PDU session away from another subscription, without the emergency call, to the particular subscription on which the emergency call originates or is active. Typically, when an emergency call is made on a first subscription, a second subscription will enter an out-of-service state (e.g., for a UE in a DSDS mode) to prevent interruption to the emergency call. By transitioning the communication link carrying the PDU session from the second subscription, without the emergency call, to the first subscription with the emergency call, the UE 120 may be enabled to use one or more operator services of the second subscription (e.g., to call a family member or a friend) while the emergency call is active on the first subscription, thereby improving performance.

As indicated above, FIG. 5 is provided as an example. Other examples may differ from what is described with regard to FIG. 5.

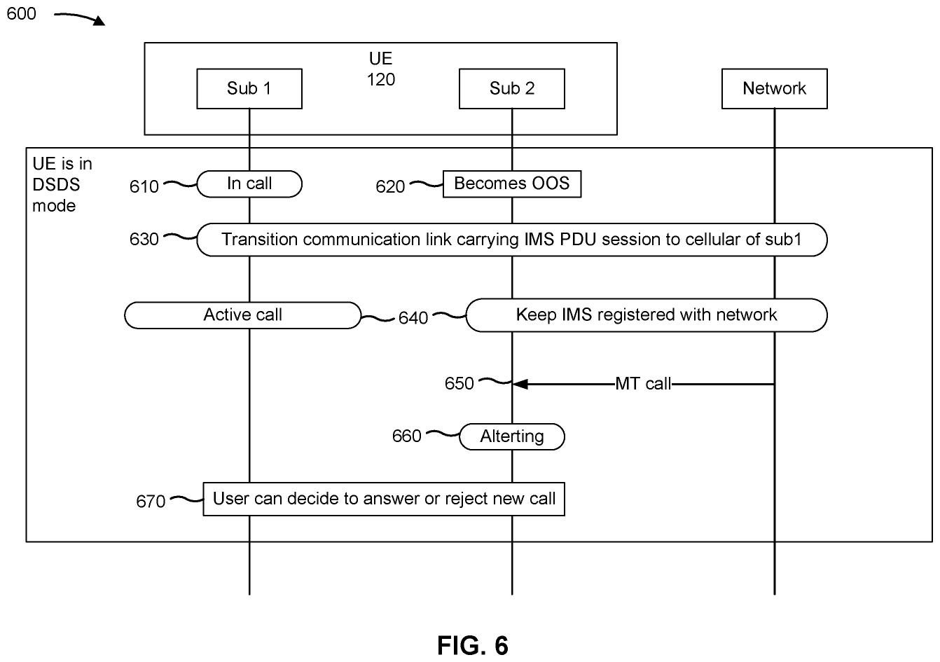

FIG. 6 is a diagram illustrating an example 600 associated with tunneling for a multi-subscription UE, in accordance with the present disclosure. As shown in FIG. 6, a UE 120 may be associated with multiple subscriptions, including a first subscription (Sub1 or Sub 1) and a second subscription (Sub2 or Sub 2). In some aspects, the UE 120 may select a first RAT for the first subscription and may communicate using the first RAT for the first subscription, such as by using one or more techniques described above in connection with FIG. 4. In some aspects, the UE 120 may select a second RAT for the second subscription and may communicate using the second RAT for the second subscription, such as by using one or more techniques described above in connection with FIG. 4. The UE 120 may communicate with a network, which may include a base station 110 and/or one or more devices included in a core network, such as a gateway (e.g., a packet data network (PDN) gateway, an ePDG gateway, and/or an N3IWF gateway).

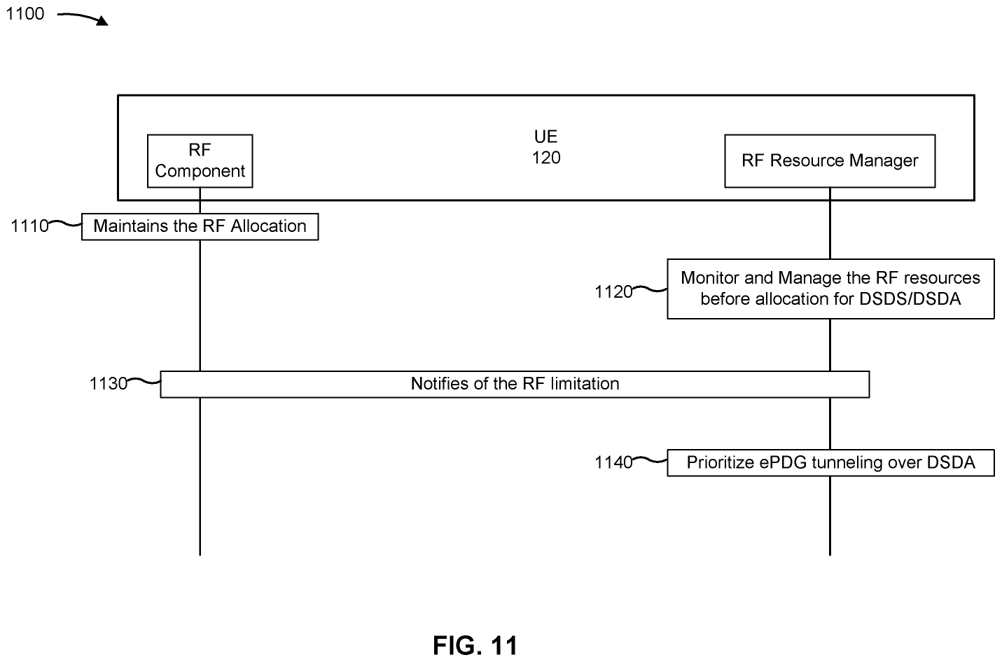

As shown by reference number 610, the first subscription may be associated with an active call (e.g., a voice call or a video call). As shown by reference number 620, when the UE 120 is operating in a DSDS mode (e.g., due to a radio frequency (RF) band limitation, as described in more detail in connection with FIG. 11), the second subscription enters an out-of-service (OOS) state due to the active call, and may remain in the OOS state during the active call on the first subscription.

As shown by reference number 630, the UE 120 may transition a communication link carrying a PDU session (shown as an “IMS PDU tunnel”, which refers to a communication link carrying an IMS PDU session) from the second subscription to the first subscription based at least in part on the active call originating on the first subscription and/or based at least in part on the second subscription entering an OOS state (e.g., due to the active call and the UE 120 being in the DSDS mode). In other words, the condition (e.g., associated with the user activity of the UE 120) described above in connection with FIG. 5 may be that an active call originates on the first subscription and/or that the second subscription enters the OOS state. The UE 120 may transition the communication link carrying the PDU session from the second subscription to the first subscription if this condition is satisfied.

As shown by reference number 640, the UE 120 may maintain an IMS registration on the second subscription after transitioning the communication link carrying the PDU session from the second subscription to the first subscription. In other words, because the UE 120 transitions the communication link carrying the PDU session from the second subscription to the first subscription, the UE 120 is enabled to maintain a first IMS registration on the first subscription and a second IMS registration on the second subscription. As a result, the UE 120 is capable of receiving a call request (e.g., a session initiation protocol (SIP) INVITE message) for the second subscription, and the UE 120 is enabled to receive calls on the second subscription.

For example, as shown by reference number 650, the UE 120 may receive a call request (e.g., for a mobile termination (MT) call). Based at least in part on receiving the call request, the UE 120 may output an alert to notify a user of an incoming call, as shown by reference number 660. As shown by reference number 670, the user can interact with the UE 120 to indicate whether to answer or reject the incoming call on the second subscription. As a result, fewer calls may be dropped.

As indicated above, FIG. 6 is provided as an example. Other examples may differ from what is described with regard to FIG. 6.

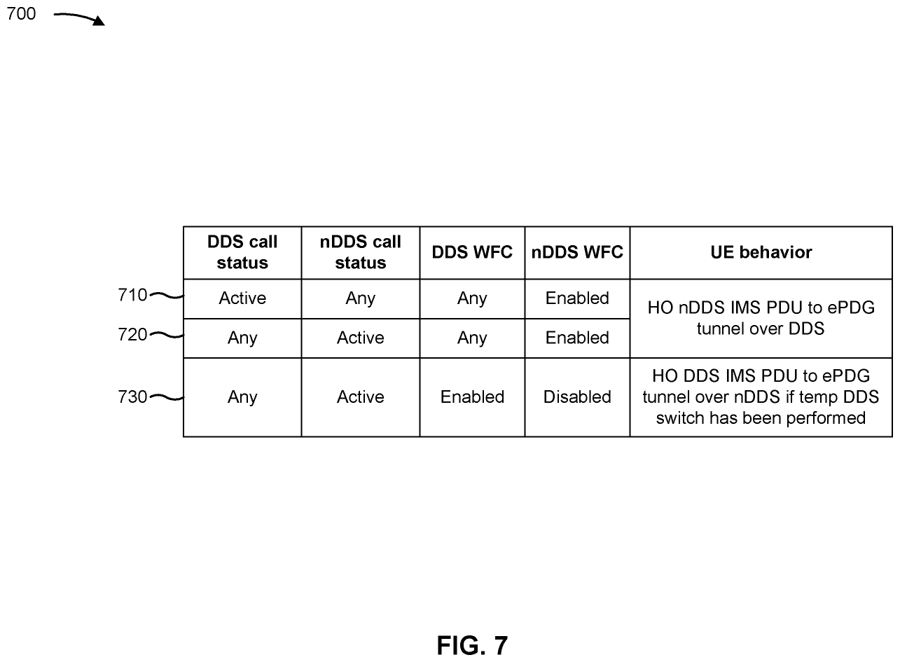

FIG. 7 is a diagram illustrating an example 700 associated with tunneling for a multi-subscription UE, in accordance with the present disclosure. As described elsewhere herein, a UE 120 may be associated with multiple subscriptions, including a DDS subscription and a non-DDS subscription. In some aspects, the UE 120 may select a first RAT for the DDS subscription and may communicate using the first RAT for the DDS subscription, such as by using one or more techniques described above in connection with FIG. 4. In some aspects, the UE 120 may select a second RAT for the non-DDS subscription and may communicate using the second RAT for the non-DDS subscription, such as by using one or more techniques described above in connection with FIG. 4. The UE 120 may communicate with a network, which may include a base station 110 and/or one or more devices included in a core network, such as a gateway (e.g., a packet data network (PDN) gateway, an ePDG gateway, and/or an N3IWF gateway).

In some aspects, when the UE 120 is operating in a DSDS mode (e.g., due to a UE capability, due to an RF band limitation, due to DSDS fallback from a DSDA mode, due to lack of network support for a DSDA mode, or due to another reason) and when one subscription is on an active call, the other subscription enters an OOS state and may remain in the OOS state during the active call. In some aspects, the UE 120 may transition a communication link carrying a PDU session from one subscription to another subscription based at least in part on one of the subscriptions entering the OOS state. In some aspects, the UE 120 may transition a communication link carrying a PDU session from a first subscription to a second subscription by moving an IMS PDU session from the first subscription to the second subscription using a communication link carrying a PDU session associated with the second subscription. In this way, the UE 120 can continue to use operator services on both subscriptions.

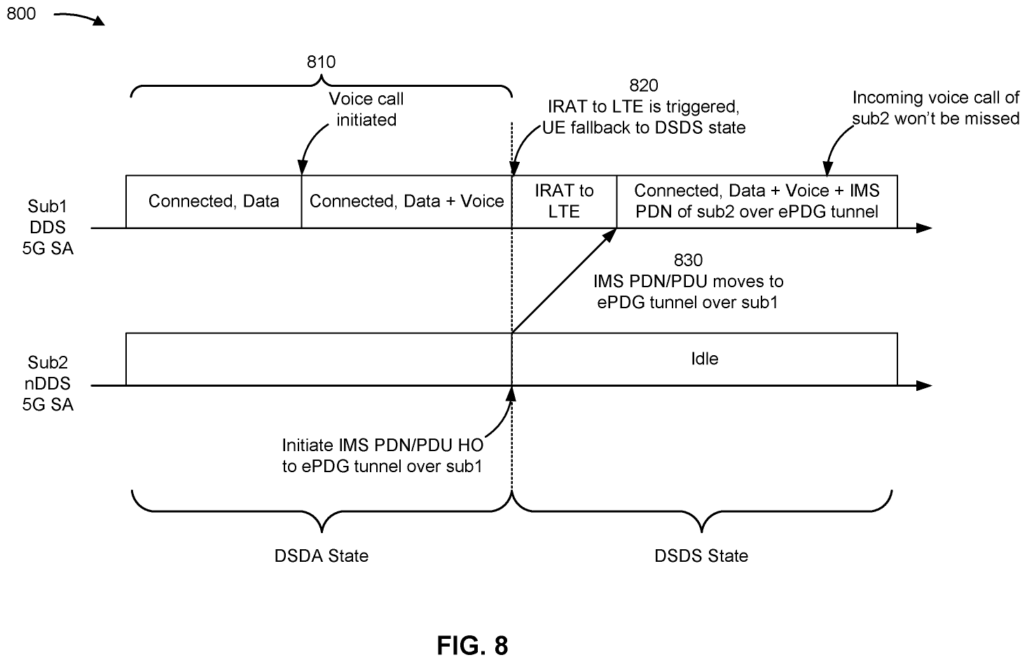

As an example, and as shown by reference number 710, if the UE 120 is in an active voice call on a DDS subscription and if a voice over WLAN service (shown as WFC for “WiFi Calling”) is enabled on a non-DDS subscription, then the UE 120 may transition (or hand over (HO)) the communication link carrying the PDU session from the non-DDS subscription to the DDS subscription. In some aspects, the UE 120 may transition the communication link carrying the PDU session from the non-DDS subscription to the DDS subscription when these conditions are satisfied regardless of whether there is an active call on the non-DDS subscription and/or regardless of whether a voice over WLAN service is enabled or disabled on the DDS subscription. Additional details of this scenario are described below in connection with FIG. 8.

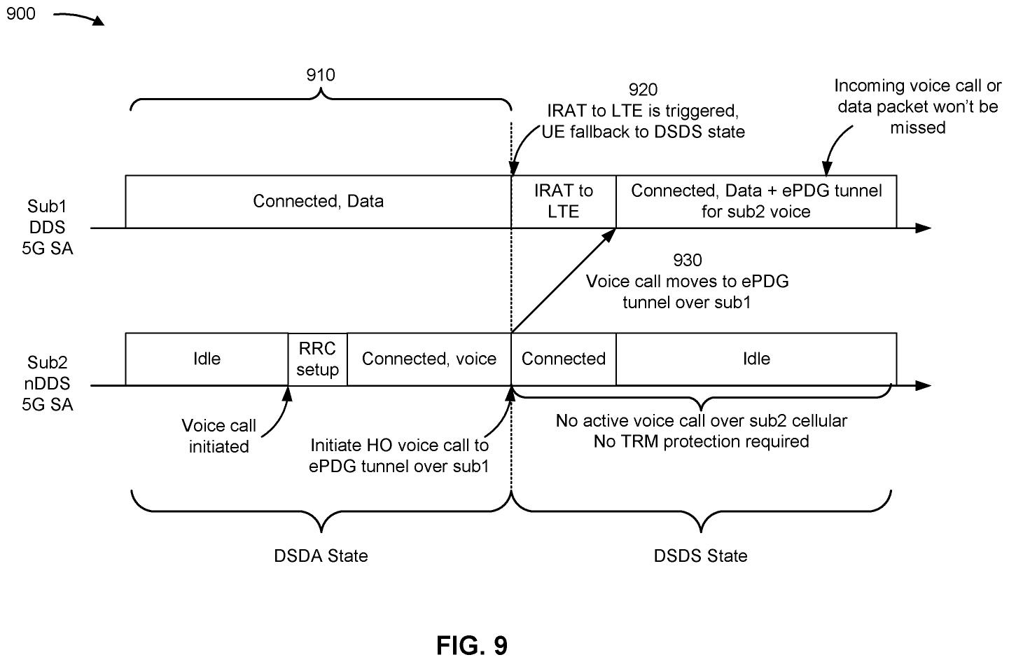

As another example, and as shown by reference number 720, if the UE 120 is in an active voice call on a non-DDS subscription and if a voice over WLAN service is enabled on the non-DDS subscription, then the UE 120 may transition the communication link carrying the PDU session from the non-DDS subscription to the DDS subscription. In some aspects, the UE 120 may transition the communication link carrying the PDU session from the non-DDS subscription to the DDS subscription when these conditions are satisfied regardless of whether there is an active call on the DDS subscription and/or regardless of whether a voice over WLAN service is enabled or disabled on the DDS subscription. Additional details of this scenario are described below in connection with FIG. 9.

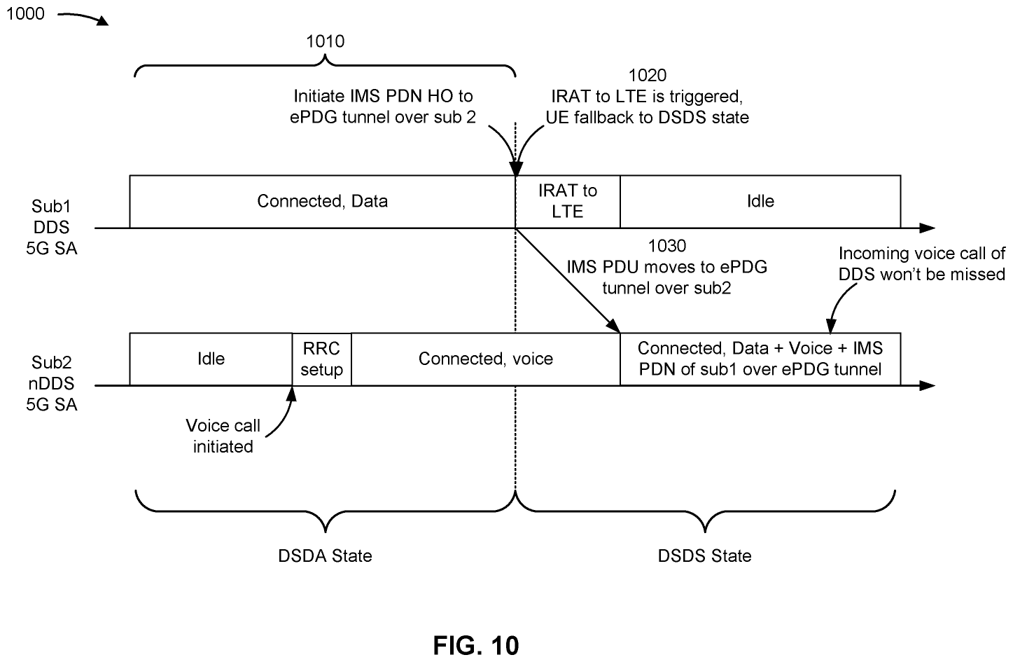

As another example, and as shown by reference number 730, if the UE 120 is in an active voice call on a second subscription (e.g., which is a non-DDS subscription prior to a temporary DDS switch), if a voice over WLAN service is disabled on the second subscription, and if a voice over WLAN service is enabled on a first subscription (e.g., which is a DDS subscription prior to a temporary DDS switch), then the UE 120 may transition the communication link carrying the PDU session from the first subscription to the second subscription. In some aspects, the UE 120 may transition the communication link carrying the PDU session from the first subscription to the second subscription when these conditions are satisfied regardless of whether there is an active call on the first subscription. Additionally, or alternatively, the UE 120 may transition the communication link carrying the PDU session from the first subscription to the second subscription when these conditions are satisfied if temporary DDS switching is enabled and if the UE 120 has performed a temporary DDS switch. “Temporary DDS switching” refers to a capability of the UE 120 to change which subscription is set as the DDS subscription. The UE 120 may perform temporary DDS switching by, for example, changing a first subscription from a DDS subscription to a non-DDS subscription and changing a second subscription from a non-DDS subscription to a DDS subscription. Additional details of this scenario are described below in connection with FIG. 10.

As indicated above, FIG. 7 is provided as an example. Other examples may differ from what is described with regard to FIG. 7.

FIG. 8 is a diagram illustrating an example 800 associated with tunneling for a multi-subscription UE, in accordance with the present disclosure. As described above in connection with reference number 710 of FIG. 7, if a UE 120 is in an active voice call on a DDS subscription and if a voice over WLAN service is enabled on a non-DDS subscription, then the UE 120 may transition a communication link carrying a PDU session from the non-DDS subscription to the DDS subscription. In example 800, the condition (e.g., associated with the user activity of the UE 120) described in connection with FIG. 5 may be that a first subscription is a DDS subscription, that a second subscription is a non-DDS subscription, that a voice call is active on the first subscription, and that voice over WLAN service is enabled on the second subscription. In some aspects, the UE 120 may transfer the communication link carrying the PDU session back to the non-DDS subscription (e.g., by moving an IMS PDU session back to the non-DDS subscription) when the active voice call on the DDS subscription ends (e.g., if a cellular signal quality of the non-DDS subscription satisfies a threshold).

In this example, the UE 120 moves the IMS PDU session of the non-DDS subscription to the DDS subscription rather than moving the DDS voice call to a communication link carrying a PDU session on the non-DDS subscription. In this way, the UE 120 may avoid a DDS switch, which may cause service interruption and/or other issues, and the UE 120 may also reduce data charges on the non-DDS subscription. In some aspects, the UE 120 does not need to measure the signal quality on the DDS subscription prior to transitioning the communication link carrying the PDU session back to the non-DDS subscription because if the signal quality on the DDS subscription becomes poor, the DDS voice call will likely end and the UE 120 may transition the DDS IMS PDU session back to the non-DDS subscription.

For example, as shown by reference number 810, a DDS subscription (e.g., a first subscription operating in a 5G standalone (SA) mode) may be in an active call. As shown by reference number 820, the UE 120 may fall back to a DSDS mode (or a DSDS state), such as due to inter-RAT handover of the first subscription from an NR RAT to an LTE RAT (e.g., that does not support a DSDA mode). As shown by reference number 830, if voice over WLAN is enabled on the non-DDS subscription, then the UE 120 may move an IMS PDU session (sometimes referred to as an IMS packet data network (PDN) session) to a communication link carrying a PDU session (e.g., an ePDG tunnel) on the DDS subscription. As a result, the UE 120 may be capable of receiving an incoming voice call associated with the second subscription while on the active voice call associated with the first subscription.

As indicated above, FIG. 8 is provided as an example. Other examples may differ from what is described with regard to FIG. 8.

FIG. 9 is a diagram illustrating an example 900 associated with tunneling for a multi-subscription UE, in accordance with the present disclosure. As described above in connection with reference number 720 of FIG. 7, if a UE 120 is in an active voice call on a non-DDS subscription and if a voice over WLAN service is enabled on the non-DDS subscription, then the UE 120 may transition a communication link carrying a PDU session from the non-DDS subscription to the DDS subscription. In example 900, the condition (e.g., associated with the user activity of the UE 120) described above in connection with FIG. 5 may be that a first subscription is a DDS, that a second subscription is a non-DDS subscription, that a voice call is active on the second subscription, and that voice over WLAN service is enabled on the second subscription. In some aspects, the UE 120 may transition the communication link carrying the PDU session only if a signal quality of the DDS subscription satisfies a threshold. In some aspects, the UE 120 may transfer the communication link carrying the PDU session back to the non-DDS subscription (e.g., by moving an IMS PDU session back to the non-DDS subscription) when the active voice call associated with the second subscription ends (e.g., if a cellular signal quality of the non-DDS subscription satisfies a threshold). Additionally, or alternatively, the UE 120 may transfer the communication link carrying the PDU session back to the non-DDS subscription when a signal quality of the DDS subscription does not satisfy a threshold (e.g., falls below a threshold, is less than or equal to a threshold, or the like) and/or when the DDS subscription goes OOS.

For example, as shown by reference number 910, a non-DDS subscription (e.g., a second subscription operating in a 5G SA mode) may be in an active call. As shown by reference number 920, the UE 120 may fall back to a DSDS mode (or a DSDS state), such as due to inter-RAT handover of the first subscription from an NR RAT to an LTE RAT (e.g., that does not support a DSDA mode). As shown by reference number 930, if voice over WLAN is enabled on the non-DDS subscription, then the UE 120 may move an IMS PDU session to a communication link carrying a PDU session on the DDS subscription. As a result, the UE 120 may be capable of receiving an incoming voice call associated with the first subscription while on the active call associated with the second subscription.

As indicated above, FIG. 9 is provided as an example. Other examples may differ from what is described with regard to FIG. 9.

FIG. 10 is a diagram illustrating an example 1000 associated with tunneling for a multi-subscription UE, in accordance with the present disclosure. As described above in connection with reference number 730 of FIG. 7, if a UE 120 is in an active voice call on a non-DDS subscription, if a voice over WLAN service is disabled on the non-DDS subscription, if a voice over WLAN service is enabled on a DDS subscription, and if the UE 120 has performed a temporary DDS switch (e.g., to temporarily set the second subscription as a DDS subscription and to set the first subscription as a non-DDS subscription), then the UE 120 may transition a communication link carrying a PDU session from the DDS subscription to the non-DDS subscription. In some aspects, the UE 120 may transfer the communication link carrying the PDU session back to the DDS subscription (e.g., by moving an IMS PDU session back to the DDS subscription) when the active voice call ends (e.g., if a cellular signal quality of the DDS subscription satisfies a threshold).

For example, as shown by reference number 1010, a non-DDS subscription (e.g., a second subscription operating in a 5G SA mode) may be in an active call. As shown by reference number 1020, the UE 120 may fall back to a DSDS mode (or a DSDS state), such as due to inter-RAT handover of the first subscription from an NR RAT to an LTE RAT (e.g., that does not support a DSDA mode). As shown by reference number 1030, if a voice over WLAN service is disabled on the second subscription, if a voice over WLAN service is enabled on the first subscription, and if the UE 120 has performed a temporary DDS switch (as described above), then the UE 120 may move an IMS PDU session to a communication link carrying a PDU session of the second subscription (e.g., which was previously a non-DDS subscription but is a DDS subscription after a temporary DDS switch). For example, the condition (e.g., associated with the user activity of the UE 120) may relate to voice over WLAN service being disabled on the second subscription. As a result, the UE 120 may be capable of receiving an incoming voice call associated with the first subscription while on the active call associated with the second subscription.

As indicated above, FIG. 10 is provided as an example. Other examples may differ from what is described with regard to FIG. 10.

FIG. 11 is a diagram illustrating an example 1100 associated with tunneling for a multi-subscription UE, in accordance with the present disclosure. As shown in FIG. 11, a UE 120 may include an RF component and an RF resource manager.

As shown by reference number 1110, the RF component may maintain an RF allocation, such as an allocation of RF bands for the first subscription and/or the second subscription. In some aspects, an RF front end may encounter an RF limitation, such as two bands or two sub-bands, on the respective subscriptions, that are incompatible due to interference or other issues (e.g., for a first low band on the first subscription and a second low band on the second subscription, or for a first ultra-high band on the first subscription and a second ultra-high band on the second subscription). Such RF limitations may be discovered by the RF resource manager during RF monitoring (sometimes referred to as scouting).

For example, as shown by reference number 1120, the RF resource manager may monitor and manage RF resources before RF allocation to different subscriptions in a DSDA mode or a DSDS mode. For example, the RF resource manager may receive an indication of a set of requested bands, and may monitor those bands. In some aspects, the RF resource manager may detect and notify of an RF limitation (e.g., incompatible bands or bands with interference), as shown by reference number 1130.

As shown by reference number 1140, if the RF resource manager detects the RF limitation associated with the first subscription and the second subscription, then the UE 120 may prioritize PDU session tunneling rather than a DSDA mode. In other words, the condition described above in connection with FIG. 5 may include an RF limitation associated with a first band for the first subscription and a second band for the second subscription. For example, the condition (e.g., associated with the device configuration of the UE 120) described above with regard to FIG. 5 may be an RF limitation associated with the first band and the second band. In this case, the UE 120 may transition a communication link carrying a PDU session from one subscription to the other subscription based at least in part on detecting the RF limitation (e.g., rather than maintaining both subscriptions as active in a DSDA mode). In this way, the UE 120 may improve performance by avoiding issues associated with RF limitations across subscriptions.

As indicated above, FIG. 11 is provided as an example. Other examples may differ from what is described with regard to FIG. 11.

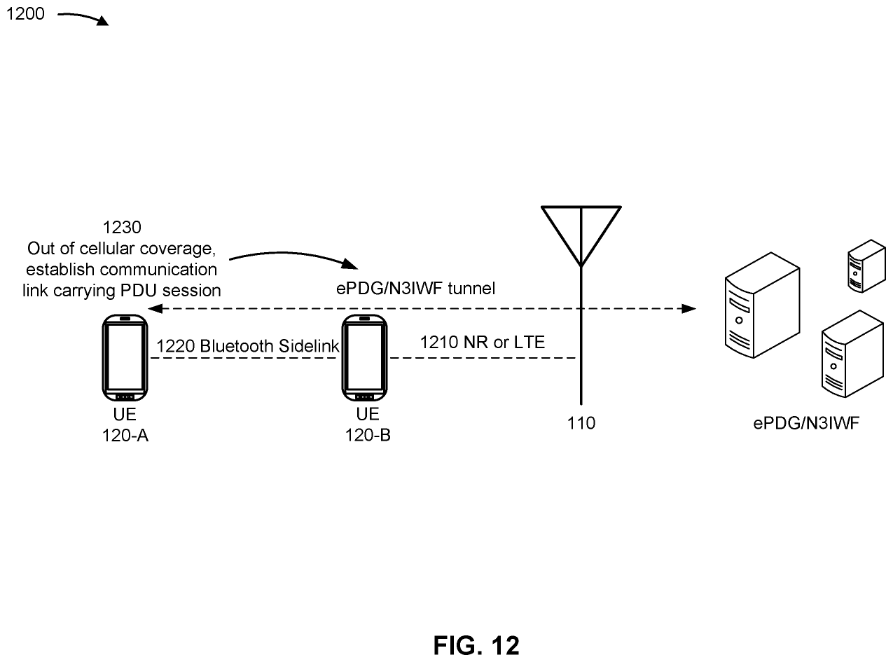

FIG. 12 is a diagram illustrating an example 1200 associated with tunneling for a multi-subscription UE, in accordance with the present disclosure. As shown in FIG. 12, a first UE 120-A may be out of cellular coverage of a base station 110. As shown by reference number 1210, a second UE 120-B may be within cellular coverage of the base station 110 (e.g., may have an NR, LTE, or other cellular connection with the base station 110). As shown by reference number 1220, the first UE 120-A and the second UE 120-B may have a network connection with one another, such as via a sidelink, a wireless personal area network (WPAN) connection (shown as Bluetooth), or the like.

As shown by reference number 1230, based at least in part on losing cellular coverage, being out of cellular coverage, being OOS, or the like, the first UE 120-A may establish a communication link carrying a PDU session (shown as an ePDG tunnel or an N3IWF tunnel), via the network connection with the second UE 120-B, to a home network of the first UE 120-A. For example, if all subscriptions of the first UE 120-A are OOS, then the first UE 120-A may establish a communication link carrying a PDU session via the second UE 120-B. As another example, if a particular subscription of the first UE 120-A is OOS, then the first UE 120-A may establish the communication link carrying the PDU session for that particular subscription. In this way, the first UE 120-A may continue to use operator services despite being OOS.

As indicated above, FIG. 12 is provided as an example. Other examples may differ from what is described with regard to FIG. 12.

FIG. 13 is a diagram illustrating an example process 1300 performed, for example, by a UE, in accordance with the present disclosure. Example process 1300 is an example where the UE (e.g., UE 120) performs operations associated with tunneling for a multi-subscription user equipment.

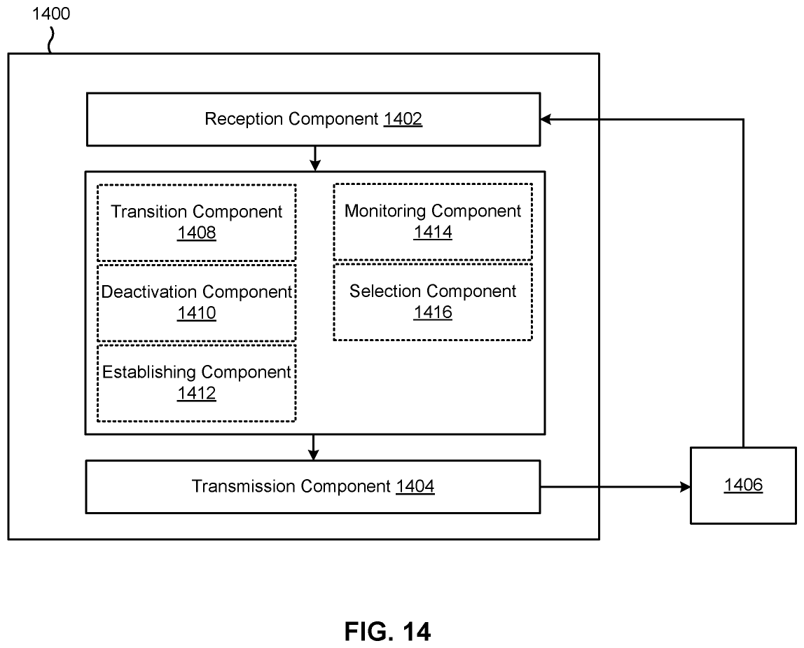

As shown in FIG. 13, in some aspects, process 1300 may include communicating using a first RAT for a first subscription of the UE, wherein the first RAT is selected from a group that includes a first cellular RAT associated with the first subscription, a second cellular RAT associated with a second subscription of the UE, and a WLAN RAT (block 1310). For example, the UE (e.g., using reception component 1402 and/or transmission component 1404, depicted in FIG. 14) may communicate using a first RAT for a first subscription of the UE, wherein the first RAT is selected from a group that includes a first cellular RAT associated with the first subscription, a second cellular RAT associated with a second subscription of the UE, and a WLAN RAT, as described above.

As further shown in FIG. 13, in some aspects, process 1300 may include communicating using a second RAT for the second subscription of the UE, wherein the second RAT is selected from the group that includes the first cellular RAT associated with the first subscription, the second cellular RAT associated with the second subscription of the UE, and the WLAN RAT (block 1320). For example, the UE (e.g., using reception component 1402 and/or transmission component 1404, depicted in FIG. 14) may communicate using a second RAT for the second subscription of the UE, wherein the second RAT is selected from the group that includes the first cellular RAT associated with the first subscription, the second cellular RAT associated with the second subscription of the UE, and the WLAN RAT, as described above.

As further shown in FIG. 13, in some aspects, process 1300 may include transitioning, based at least in part on a condition, a communication link carrying a PDU session from the second subscription to the first subscription (block 1330). For example, the UE (e.g., using transition component 1408, depicted in FIG. 14) may transition, based at least in part on a condition, a communication link carrying a PDU session from the second subscription to the first subscription, as described above. In some aspects, the condition is associated with a user activity of the UE or a condition associated with a device configuration of the UE.

Process 1300 may include additional aspects, such as any single aspect or any combination of aspects described below and/or in connection with one or more other processes described elsewhere herein.

In a first aspect, process 1300 includes deactivating a cellular radio component associated with the second subscription based at least in part on transitioning the communication link carrying the PDU session from the second subscription to the first subscription.

In a second aspect, alone or in combination with the first aspect, the condition is that a remaining battery power of the UE is less than or equal to a battery power threshold.

In a third aspect, alone or in combination with one or more of the first and second aspects, the condition is that a first signal quality associated with the first RAT used for the first subscription exceeds a second signal quality associated with the second RAT used for the second subscription.

In a fourth aspect, alone or in combination with one or more of the first through third aspects, the condition is that the first subscription is a DDS and the second subscription is a non-DDS subscription.

In a fifth aspect, alone or in combination with one or more of the first through fourth aspects, the communication link carrying the PDU session is a communication link carrying an IMS PDU session, and process 1300 includes maintaining a first IMS registration on the first subscription and a second IMS registration on the second subscription after transitioning the communication link carrying the PDU session from the second subscription to the first subscription.

In a sixth aspect, alone or in combination with one or more of the first through fifth aspects, the condition is that the first subscription is a DDS, that the second subscription is a non-DDS subscription, that a voice call is active on the first subscription, and that voice over WLAN service is enabled on the second subscription.

In a seventh aspect, alone or in combination with one or more of the first through sixth aspects, the condition is that the first subscription is a DDS, that the second subscription is a non-DDS subscription, that a voice call is active on the second subscription, and that voice over WLAN service is enabled on the second subscription.

In an eighth aspect, alone or in combination with one or more of the first through seventh aspects, the condition is that voice over WLAN service is disabled on the second subscription.

In a ninth aspect, alone or in combination with one or more of the first through eighth aspects, the condition is that a call that originates on the second subscription experiences a call failure, and process 1300 includes attempting the call on the first subscription after transitioning the communication link carrying the PDU session from the second subscription to the first subscription.

In a tenth aspect, alone or in combination with one or more of the first through ninth aspects, the condition is a radio frequency limitation associated with a first band for the first subscription and a second band for the second subscription.

In an eleventh aspect, alone or in combination with one or more of the first through tenth aspects, the condition is a high priority operation or a latency-sensitive operation associated with the first subscription.

In a twelfth aspect, alone or in combination with one or more of the first through eleventh aspects, the condition is that Internet Protocol Multimedia Subsystem (IMS) service is not available for the second subscription.

In a thirteenth aspect, alone or in combination with one or more of the first through twelfth aspects, the condition is a prediction of an event that will impact service on the second subscription.

In a fourteenth aspect, alone or in combination with one or more of the first through thirteenth aspects, the event is predicted based at least in part on applying one or more machine learning techniques.

In a fifteenth aspect, alone or in combination with one or more of the first through fourteenth aspects, the condition is an emergency call on the first subscription.

In a sixteenth aspect, alone or in combination with one or more of the first through fifteenth aspects, process 1300 includes establishing a tunnel to a home network of the UE, via a network connection with another UE, based at least in part on detecting a loss of cellular coverage for the UE.

In a seventeenth aspect, alone or in combination with one or more of the first through sixteenth aspects, at least one of the first RAT for the first subscription or the second RAT for the second subscription is selected based at least in part on at least one of a user setting stored by the UE, a RAT preference associated with at least one of the first cellular RAT, the second cellular RAT, or the WLAN RAT, at least one of an availability of the first cellular RAT, an availability of the second cellular RAT, or an availability of the WLAN RAT, or a signal quality measured for at least one of the first cellular RAT, the second cellular RAT, or the WLAN RAT.

In an eighteenth aspect, alone or in combination with one or more of the first through seventeenth aspects, process 1300 includes monitoring at least one of availability or signal quality for at least one of the first cellular RAT, the second cellular RAT, or the WLAN RAT, selecting a different RAT, than the selected RAT, based at least in part on monitoring at least one of the availability or the signal quality, and communicating on the first subscription using the selected different RAT.

In a nineteenth aspect, alone or in combination with one or more of the first through eighteenth aspects, the communication link carrying the PDU session includes at least one of an evolved packet data gateway tunnel or a non-3GPP interworking function tunnel.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a block diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include one or more of a transition component 1408, a deactivation component 1410, an establishing component 1412, a monitoring component 1414, or a selection component 1416, among other examples.

In some aspects, the apparatus 1400 may be configured to perform one or more operations described herein in connection with FIGS. 4-12. Additionally, or alternatively, the apparatus 1400 may be configured to perform one or more processes described herein, such as process 1300 of FIG. 13. In some aspects, the apparatus 1400 and/or one or more components shown in FIG. 14 may include one or more components of the UE described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the UE described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the UE described above in connection with FIG. 2. In some aspects, the transmission component 1404 may be co-located with the reception component 1402 in a transceiver.

The reception component 1402 and/or the transmission component 1404 may communicate using a first RAT for a first subscription of the UE, wherein the first RAT is selected from a group that includes a first cellular RAT associated with the first subscription, a second cellular RAT associated with a second subscription of the UE, and a WLAN RAT. The reception component 1402 and/or the transmission component 1404 may communicate using a second RAT for the second subscription of the UE, wherein the second RAT is selected from the group that includes the first cellular RAT associated with the first subscription, the second cellular RAT associated with the second subscription of the UE, and the WLAN RAT. The transition component 1408 may transition, based at least in part on a condition, a communication link carrying a PDU session from the second subscription to the first subscription.

The deactivation component 1410 may deactivate a cellular radio component associated with the second subscription based at least in part on transitioning the communication link carrying the PDU session from the second subscription to the first subscription. The establishing component 1412 may establish a tunnel to a home network of the UE, via a network connection with another UE, based at least in part on detecting a loss of cellular coverage for the UE. The monitoring component 1414 may monitor at least one of availability or signal quality for at least one of the first cellular RAT, the second cellular RAT, or the WLAN RAT. The selection component 1416 may select a different RAT, than the selected RAT, based at least in part on monitoring at least one of the availability or the signal quality. The reception component 1402 and/or the transmission component 1404 may communicate on the first subscription using the selected different RAT.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: communicating using a first radio access technology (RAT) for a first subscription of the UE, wherein the first RAT is selected from a group that includes a first cellular RAT associated with the first subscription, a second cellular RAT associated with a second subscription of the UE, and a wireless local area network (WLAN) RAT; communicating using a second RAT for the second subscription of the UE, wherein the second RAT is selected from the group that includes the first cellular RAT associated with the first subscription, the second cellular RAT associated with the second subscription of the UE, and the WLAN RAT; and transitioning, based at least in part on a condition associated with a user activity of the UE or a condition associated with a device configuration of the UE, a communication link carrying a protocol data unit (PDU) session from the second subscription to the first subscription.

Aspect 2: The method of Aspect 1, further comprising deactivating a cellular radio component associated with the second subscription based at least in part on transitioning the communication link carrying the PDU session from the second subscription to the first subscription.

Aspect 3: The method of any of Aspects 1-2, wherein the condition is that a remaining battery power of the UE is less than or equal to a battery power threshold.

Aspect 4: The method of any of Aspects 1-3, wherein the condition is that a first signal quality associated with the first RAT used for the first subscription exceeds a second signal quality associated with the second RAT used for the second subscription.

Aspect 5: The method of any of Aspects 1-4, wherein the condition is that the first subscription is a default data subscription (DDS) and the second subscription is a non-DDS subscription.

Aspect 6: The method of any of Aspects 1-5, wherein the communication link carrying the PDU session is a communication link carrying an IMS PDU session; and further comprising maintaining a first IMS registration on the first subscription and a second IMS registration on the second subscription after transitioning the communication link carrying the PDU session from the second subscription to the first subscription.

Aspect 7: The method of any of Aspects 1-6, wherein the condition is that the first subscription is a default data subscription (DDS), that the second subscription is a non-DDS subscription, that a voice call is active on the first subscription, and that voice over WLAN service is enabled on the second subscription.

Aspect 8: The method of any of Aspects 1-6, wherein the condition is that the first subscription is a default data subscription (DDS), that the second subscription is a non-DDS subscription, that a voice call is active on the second subscription, and that voice over WLAN service is enabled on the second subscription.

Aspect 9: The method of any of Aspects 1-6, wherein the condition is that voice over WLAN service is disabled on the second subscription.

Aspect 10: The method of Aspect 1, wherein the condition is that a call that originates on the second subscription experiences a call failure; and further comprising attempting the call on the first subscription after transitioning the communication link carrying the PDU session from the second subscription to the first subscription.

Aspect 11: The method of Aspect 1, wherein the condition is a radio frequency limitation associated with a first band for the first subscription and a second band for the second subscription.

Aspect 12: The method of Aspect 1, wherein the condition is a high priority operation or a latency-sensitive operation associated with the first subscription.

Aspect 13: The method of Aspect 1, wherein the condition is that Internet Protocol Multimedia Subsystem (IMS) service is not available for the second subscription.

Aspect 14: The method of Aspect 1, wherein the condition is a prediction of an event that will impact service on the second subscription.

Aspect 15: The method of Aspect 14, wherein the event is predicted based at least in part on applying one or more machine learning techniques.

Aspect 16: The method of Aspect 1, wherein the condition is an emergency call on the first subscription.

Aspect 17: The method of any of Aspects 1-16, further comprising establishing a tunnel to a home network of the UE, via a network connection with another UE, based at least in part on detecting a loss of cellular coverage for the UE.

Aspect 18: The method of any of Aspects 1-17, wherein at least one of the first RAT for the first subscription or the second RAT for the second subscription is selected based at least in part on at least one of: a user setting stored by the UE; a RAT preference associated with at least one of the first cellular RAT, the second cellular RAT, or the WLAN RAT; at least one of an availability of the first cellular RAT, an availability of the second cellular RAT, or an availability of the WLAN RAT; or a signal quality measured for at least one of the first cellular RAT, the second cellular RAT, or the WLAN RAT.

Aspect 19: The method of any of Aspects 1-18, further comprising: monitoring at least one of availability or signal quality for at least one of the first cellular RAT, the second cellular RAT, or the WLAN RAT; selecting a different RAT, than the selected RAT, based at least in part on monitoring at least one of the availability or the signal quality; and communicating on the first subscription using the selected different RAT.

Aspect 20: The method of any of Aspects 1-19, wherein the communication link carrying the PDU session includes at least one of an evolved packet data gateway tunnel or a non-3GPP interworking function tunnel.

Aspect 21: A method of wireless communication performed by a user equipment (UE), comprising: communicate using a first radio access technology (RAT) for a first subscription of the UE, wherein the first RAT is a cellular RAT associated with the first subscription, where the UE is associated with a second subscription that can communicate using a communication link carrying a protocol data unit (PDU session) on the first RAT of the first subscription; and establish, with a gateway, a communication link carrying a protocol data unit (PDU) session on the first RAT of the first subscription.

Aspect 22: The method of Aspect 21, further comprising transition the communication link to a cellular RAT of the second subscription.

Aspect 23: The method of one or more of Aspects 21 and 22, wherein the UE is associated with a single subscriber identity module (SIM).

Aspect 24: The method of Aspect 23, wherein the first subscription and the second subscription are the same subscription.

Aspect 25: An apparatus for wireless communication at a device, comprising a processor; memory coupled with the processor; and instructions stored in the memory and executable by the processor to cause the apparatus to perform the method of one or more Aspects of Aspects 1-24.

Aspect 26: A device for wireless communication, comprising a memory and one or more processors coupled to the memory, the memory and the one or more processors configured to perform the method of one or more Aspects of Aspects 1-24.

Aspect 27: An apparatus for wireless communication, comprising at least one means for performing the method of one or more Aspects of Aspects 1-24.

Aspect 28: A non-transitory computer-readable medium storing code for wireless communication, the code comprising instructions executable by a processor to perform the method of one or more Aspects of Aspects 1-24.

Aspect 29: A non-transitory computer-readable medium storing a set of instructions for wireless communication, the set of instructions comprising one or more instructions that, when executed by one or more processors of a device, cause the device to perform the method of one or more Aspects of Aspects 1-24.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
communicate using a first radio access technology (RAT) for a first subscription of the UE, wherein the first RAT is selected from a group that includes a first cellular RAT associated with the first subscription, a second cellular RAT associated with a second subscription of the UE, and a wireless local area network (WLAN) RAT;
communicate using a second RAT for the second subscription of the UE, wherein the second RAT is selected from the group that includes the first cellular RAT associated with the first subscription, the second cellular RAT associated with the second subscription of the UE, and the WLAN RAT; and
transition, based at least in part on a condition associated with a user activity of the UE or a condition associated with a device configuration of the UE, a communication link carrying a protocol data unit (PDU) session from the second subscription to the first subscription.

2. The apparatus of claim 1, wherein the one or more processors are further configured to deactivate a cellular radio component associated with the second subscription based at least in part on transitioning the communication link carrying the PDU session from the second subscription to the first subscription.

3. The apparatus of claim 1, wherein the condition associated with the device configuration of the UE is that a remaining battery power of the UE is less than or equal to a battery power threshold.

4. The apparatus of claim 1, wherein the condition associated with the device configuration of the UE is that the first subscription is a default data subscription (DDS) and the second subscription is a non-DDS subscription.

5. The apparatus of claim 1, wherein the communication link carrying the PDU session is a communication link carrying an IMS PDU session; and
further comprise maintaining a first IMS registration on the first subscription and a second IMS registration on the second subscription after transitioning the communication link carrying the PDU session from the second subscription to the first subscription.

6. The apparatus of claim 1, wherein the condition associated with the user activity of the UE is that the first subscription is a default data subscription (DDS), that the second subscription is a non-DDS subscription, that a voice call is active on the first subscription, and that voice over WLAN service is enabled on the second subscription.

7. The apparatus of claim 1, wherein the condition associated with the user activity of the UE is that the first subscription is a default data subscription (DDS), that the second subscription is a non-DDS subscription, that a voice call is active on the second subscription, and that voice over WLAN service is enabled on the second subscription.

8. The apparatus of claim 1, wherein the condition associated with the user activity of the UE is that voice over WLAN service is disabled on the second subscription.

9. The apparatus of claim 1, wherein the condition associated with the user activity of the UE is that a call that originates on the second subscription experiences a call failure; and
further comprising attempting the call on the first subscription after transitioning the communication link carrying the PDU session from the second subscription to the first subscription.

10. The apparatus of claim 1, wherein the condition associated with the device configuration of the UE is a radio frequency limitation associated with a first band for the first subscription and a second band for the second subscription.

11. The apparatus of claim 1, wherein the condition associated with the user activity of the UE is a high priority operation or a latency-sensitive operation associated with the first subscription.

12. The apparatus of claim 1, wherein the condition associated with the user activity of the UE is that Internet Protocol Multimedia Subsystem (IMS) service is not available for the second subscription.

13. The apparatus of claim 1, wherein the condition associated with the device configuration of the UE is a prediction of an event that will impact service on the second subscription.

14. The apparatus of claim 13, wherein the event is predicted based at least in part on applying one or more machine learning techniques.

15. The apparatus of claim 1, wherein the condition associated with the user activity of the UE is an emergency call on the first subscription.

16. The apparatus of claim 1, wherein the one or more processors are further configured to establish a tunnel to a home network of the UE, via a network connection with another UE, based at least in part on detecting a loss of cellular coverage for the UE.

17. The apparatus of claim 1, wherein at least one of the first RAT for the first subscription or the second RAT for the second subscription is selected based at least in part on at least one of:
a user setting stored by the UE;
a RAT preference associated with at least one of the first cellular RAT, the second cellular RAT, or the WLAN RAT;
at least one of an availability of the first cellular RAT, an availability of the second cellular RAT, or an availability of the WLAN RAT; or
a signal quality measured for at least one of the first cellular RAT, the second cellular RAT, or the WLAN RAT.

18. The apparatus of claim 1, wherein the one or more processors are further configured to:
monitor at least one of availability or signal quality for at least one of the first cellular RAT, the second cellular RAT, or the WLAN RAT;
select a different RAT, than the selected RAT, based at least in part on monitoring at least one of the availability or the signal quality; and
communicate on the first subscription using the selected different RAT.

19. The apparatus of claim 1, wherein the communication link carrying the PDU session includes at least one of an evolved packet data gateway tunnel or a non-3GPP interworking function tunnel.

20. A method of wireless communication performed by a user equipment (UE), comprising:
communicating using a first radio access technology (RAT) for a first subscription of the UE, wherein the first RAT is selected from a group that includes a first cellular RAT associated with the first subscription, a second cellular RAT associated with a second subscription of the UE, and a wireless local area network (WLAN) RAT;
communicating using a second RAT for the second subscription of the UE, wherein the second RAT is selected from the group that includes the first cellular RAT associated with the first subscription, the second cellular RAT associated with the second subscription of the UE, and the WLAN RAT; and
transitioning, based at least in part on a condition associated with a user activity of the UE or a condition associated with a device configuration of the UE, a communication link carrying a protocol data unit (PDU) session from the second subscription to the first subscription.

21. The method of claim 20, further comprising deactivating a cellular radio component associated with the second subscription based at least in part on transitioning the communication link carrying the PDU session from the second subscription to the first subscription.

22. The method of claim 20, wherein the condition associated with the device configuration of the UE is that a remaining battery power of the UE is less than or equal to a battery power threshold.

23. The method of claim 20, wherein the condition associated with the device configuration of the UE is that the first subscription is a default data subscription (DDS) and the second subscription is a non-DDS subscription.

24. The method of claim 20, wherein the communication link carrying the PDU session is a communication link carrying an IMS PDU session; and
further comprising maintaining a first IMS registration on the first subscription and a second IMS registration on the second subscription after transitioning the communication link carrying the PDU session from the second subscription to the first subscription.

25. The method of claim 20, wherein the condition associated with the user activity of the UE is that the first subscription is a default data subscription (DDS), that the second subscription is a non-DDS subscription, that a voice call is active on the first subscription, and that voice over WLAN service is enabled on the second subscription.

26. An apparatus for wireless communication at a user equipment (UE), comprising:
a memory; and
one or more processors, coupled to the memory, configured to:
communicate using a first radio access technology (RAT) for a first subscription of the UE, wherein the first RAT is a cellular RAT associated with the first subscription, where the UE is associated with a second subscription that can communicate using a communication link carrying a protocol data unit (PDU) session on the first RAT of the first subscription; and
establish, with a gateway, the communication link carrying the PDU session on the first RAT of the first subscription.

27. The apparatus of claim 26, wherein the one or more processors are configured to transition the communication link to the first RAT of the first subscription.

28. The apparatus of claim 26, wherein the UE is associated with a single subscriber identity module (SIM).

29. The apparatus of claim 28, wherein the first subscription and the second subscription are the same subscription.

30. A non-transitory computer-readable medium storing a set of instructions for wireless communication, the set of instructions comprising:
one or more instructions that, when executed by one or more processors of a user equipment (UE), cause the UE to:
communicate using a first radio access technology (RAT) for a first subscription of the UE, wherein the first RAT is selected from a group that includes a first cellular RAT associated with the first subscription, a second cellular RAT associated with a second subscription of the UE, and a wireless local area network (WLAN) RAT;
communicate using a second RAT for the second subscription of the UE, wherein the second RAT is selected from the group that includes the first cellular RAT associated with the first subscription, the second cellular RAT associated with the second subscription of the UE, and the WLAN RAT; and
transition, based at least in part on a condition associated with a user activity of the UE or a condition associated with a device configuration of the UE, a communication link carrying a protocol data unit (PDU) session from the second subscription to the first subscription.
